(19) United States
(12) Patent Application Publication
(10) Pub. No.: US 2014/0040259 A1
(43) Pub. Date: Feb. 6, 2014

(54) INFORMATION PROCESSING APPARATUS AND INFORMATION PROCESSING METHOD

(71) Applicant: Sony Corporation, Tokyo (JP)

(72) Inventors: Machiko TAKEMATSU, Kanagawa (JP); Yasuko MIURA, Tokyo (JP); Tomoko TANAKA, Kanagawa (JP); Ryuji TANABE, Kanagawa (JP); Daisaku HAYASHI, Chiba (JP); Atsuhiro YAMAOKA, Kanagawa (JP); Takayuki FUJINAGA, Nagano (JP); Tsunayuki OHWA, Kanagawa (JP)

(21) Appl. No.: 13/932,142

(22) Filed: Jul. 1, 2013

(30) Foreign Application Priority Data
Aug. 2, 2012 (JP) 2012-172042

(51) Int. Cl. G06F 17/30

(52) U.S. Cl. CPC G06F 17/30595
USPC 707/736

(57) ABSTRACT

There is provided an information processing apparatus including a user information manager that registers, in a database, registered device information in which devices specified by a user from among devices capable of realizing functions by linking together are associated with the user, a recommended function determiner that acquires, from the database, function information in which the functions and the devices are associated, and determines recommended functions for the user on the basis of the function information and the registered device information, and a procedure information manager that acquires, from the database, procedure information indicating operating procedures for realizing a function that the user selects from among the recommended functions, and provides the procedure information to the user.

### BACKGROUND

The present disclosure relates to an information processing apparatus and an information processing method.

It is already becoming typical to have multiple devices in a home or other location function in a linked manner. Various functions are realized by device linkage, such as having photos, videos, music, or other content saved on one device be played back an another device, using a recorder to immediately record a program being viewed on a television, or having a program recorded on a recorder be played back on a television or other device in another room.

However, when attempting to realize functions by device linkage, there is a wide variety of functions which may be realized, and since these functions vary depending on what combination of devices a user owns, it has been difficult for a user to grasp all of these functions and select a function to use. Consequently, there are many functions which, although realizable, go unrecognized by a user, and remain undiscovered despite being useful for the user.

Accordingly, there has been proposed technology such as the technology described in Japanese Unexamined Patent Application Publication No. 2011-253370, for example, that automatically rates functions which may be realized by the linkage of devices connected to a network in a home or other location, and utilizes the rating results to recommend functions to a user. According to such technology, a user is able to easily recognize which functions are suitable from among the functions that are realizable with the devices that the user owns, and the user is able to utilize the more useful functions.

### SUMMARY

The technology in Japanese Unexamined Patent Application Publication No. 2011-253370 above also includes acquiring information on a procedure for configuring devices in order to realize a recommended function. However, the function and procedure information acquired at this point is information prepared in advance, such as information stated in an instruction manual, for example. Such information is useful to a user in order to utilize a function.

Recently, however, there has been a tremendous increase in functions realizable by device linkage, due to factors such as faster information processing functions included in devices, and greater standardization across devices. In some cases, there are discovered new functions that were not anticipated at the time of device manufacturing. Given such circumstances, the above technology may be insufficient at providing more effective information that accounts for factors such as a user's device environment.

Thus, the present disclosure proposes a new and improved information processing apparatus and information processing method capable of effectively supporting the utilization of functions realized by device linkage.

According to an embodiment of the present disclosure, there is provided an information processing apparatus including a user information manager that registers, in a database, registered device information in which devices specified by a user from among devices capable of realizing functions by linking together are associated with the user, a recommended function determiner that acquires, from the database, function information in which the functions and the devices are associated, and determines recommended functions for the user on the basis of the function information and the registered device information, and a procedure information manager that acquires, from the database, procedure information indicating operating procedures for realizing a function that the user selects from among the recommended functions, and provides the procedure information to the user.

Further, according to an embodiment of the present disclosure, there is provided an information processing apparatus including a device information acquirer that acquires information on devices specified by a user from among devices capable of realizing functions by linking together, and transmits the information to a server in order to register the acquired information as registered device information associated with the user, and a receiver that receives procedure information indicating operating procedures for realizing a function selected by the user from among recommended functions for the user that are determined on the basis of device information in which the functions and the devices are associated, and the registered device information.

Further, according to an embodiment of the present disclosure, there is provided an information processing method including registering, in a database, registered device information in which devices specified by a user from among devices capable of realizing functions by linking together are associated with the user, acquiring, from the database, function information in which the functions and the devices are associated, and determining recommended functions for the user on the basis of the function information and the registered device information, and acquiring, from the database, procedure information indicating operating procedures for realizing a function that the user selects from among the recommended functions, and providing the procedure information to the user.

By determining recommended functions on the basis of registered device information and function information, it is possible to make recommendations for functions that are realizable by the linkage of devices that a user owns or is considering owning, and recommend functions that are more useful to the user. Moreover, by selecting procedure information for a function that the user selects from among the recommended functions, it becomes easy for the user to execute an operating procedure for realizing a function.

According to embodiments of the present disclosure, it is possible to effectively support the utilization of functions realized by device linkage.

### BRIEF DESCRIPTION OF THE DRAWINGS

FIG. 1 is a diagram summarizing a system according to an embodiment of the present disclosure;

FIG. 2 is a diagram that schematically illustrates an example of a database (DB) structure according to an embodiment of the present disclosure;

FIG. 3 is a diagram illustrating an example of procedure information according to an embodiment of the present disclosure;

FIG. 4 is a diagram that schematically illustrates a functional configuration of a system according to an embodiment of the present disclosure;

FIG. 5 is a diagram illustrating an example of display screens in a device registration process according to an embodiment of the present disclosure;

FIG. 6 is a diagram illustrating an example of a process flow in a device registration process according to an embodiment of the present disclosure;

FIG. 7 is a diagram illustrating an example of display screens in a procedure registration process (manual) according to an embodiment of the present disclosure;

FIG. 8 is a diagram illustrating an example of a flow of the process illustrated in FIG. 7;

FIG. 9 is a diagram illustrating an example of display screens in a procedure registration process (semi-automatic) according to an embodiment of the present disclosure;

FIG. 10 is a diagram illustrating an example of a flow of the process illustrated in FIG. 9;

FIG. 11 is a diagram illustrating an example of display screens in a procedure registration process (automatic) according to an embodiment of the present disclosure;

FIG. 12 is a diagram illustrating an example of display screens in a procedure execution process according to an embodiment of the present disclosure;

FIG. 13 is a diagram illustrating an example of a flow of the process illustrated in FIG. 12;

FIG. 14 is a diagram illustrating an example of a process flow in an SNS link process according to an embodiment of the present disclosure;

FIG. 15 is a diagram illustrating an example of device control according to an embodiment of the present disclosure;

FIG. 16 is a diagram illustrating another example of device control according to an embodiment of the present disclosure;

FIG. 17 is a diagram illustrating an example of the user interface from the example in FIG. 16;

FIG. 18 is a diagram illustrating an example of displaying a link function overview on the user interface in FIG. 17;

FIG. 19 is a diagram illustrating an example of executing a link function switch on the user interface in FIG. 17; and

FIG. 20 is a block diagram for describing a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order.

1. System Configuration
1-1. Overview
1-2. Exemplary DB structure
1-3. Exemplary functional configuration

2. Device Registration Process

3. Procedure Registration Process

4. Procedure Execution Process

5. SNS Link Process

6. Controlling Linked Devices

7. Rating and Recommending Functions

8. Hardware Configuration

9. Supplemental Remarks

(1. System Configuration)

(1-1. Overview)

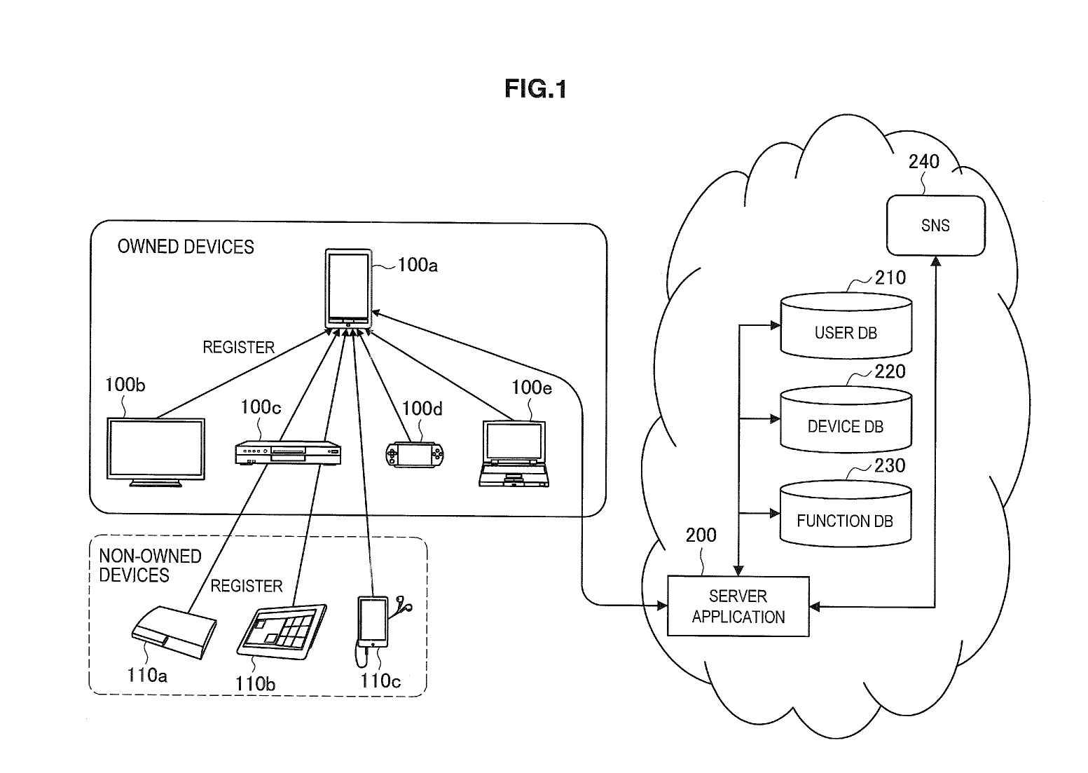

FIG. 1 is a diagram summarizing a system according to an embodiment of the present disclosure. In the present embodiment, a user is able to register owned devices 100 and non-owned devices 110 in a system. In the example illustrated in FIG. 1, one of the devices owned by the user, a smartphone 100a, is used to execute registration. Registration information is transmitted to a server and processed by a server application 200. A user database (DB) 210, a device DB 220, and a function DB 230 exist on the server. These DBs store information such as information on devices registered by a user, and information on functions realized by the linkage of devices. Information is added to, updated, or deleted from each DB on the basis of information provided by the manufacturer of each device, for example.

The server application 200 manages information stored in these DBs, and also utilizes information stored in the DBs to provide an owned device 100 (in the example illustrated in FIG. 1, the smartphone 100a) with information such as information related to functions realized by the linkage of devices, as discussed later. The device provided with information may not be the same as the device that transmitted registration information. Consequently, in the example illustrated in FIG. 1, the server application 200 may also provide information related to functions realized by the linkage of devices to a TV 100b, a recorder 100c, a game console 100d, or a personal computer (PC) 100e. In addition, the server application 200 may also access a social network service (SNS) 240 in order to issue various notifications to the user, for example.

The owned devices 100 are devices that the user actually owns or uses. The owned devices 100 do not necessarily exist in the same place, and may be disposed in various places, such as at home, at a workplace, or be portable, for example. The user uses one of the owned devices, such as the smartphone 100a, for example, to register the other owned devices 100b to 100e. At this time, the smartphone 100a may also be registered. Registration is executable by various methods, such as by taking photos or inputting model numbers, as discussed later.

Herein, the role of each of the owned devices 100 during registration is interchangeable if an application for device registration is installed in each of the owned devices 100, for example. In other words, although the smartphone 100a is registering the other owned devices 100b to 100e in the example illustrated in FIG. 1, the same role may also be performed by the TV 100b, the recorder 100c, the game console 100d, or the PC 100e, for example. As above, registration is executable by various methods. For this reason, each of the owned devices 100 may be capable of registering other owned devices 100 by a realizable method (such as recorder 100c, which does not take photos, performing registration primarily by inputting model numbers, for example).

Meanwhile, the non-owned devices 110 (the devices 110a to 110c) are devices that the user does not actually own. These non-owned devices 110 may also be registrable similarly to the owned devices 100. Since there is a high likelihood that the non-owned devices 110 are not within the user's reach, registration may be performed primarily by inputting model numbers or the like. At this point, since it is not easy to know the model number of a device that the user does not own, information such as a link for executing registration from a catalog site on the Internet may also be provided, for example. Alternatively, the user may register a device by taking a photo of a borrowed device or a device seen in a shop, for example.

(1-2. Exemplary DB Structure)

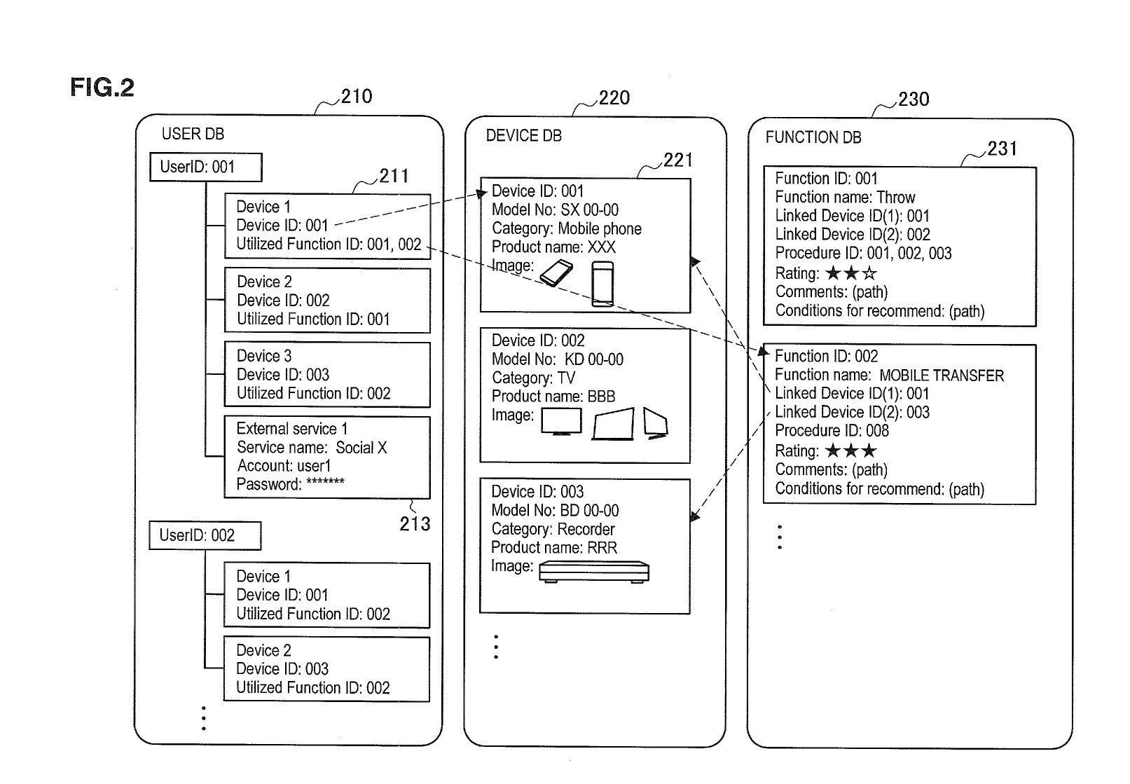

FIG. 2 is a diagram that schematically illustrates an example of a database (DB) structure according to an embodiment of the present disclosure. In the present embodiment, a user DB 210, a device DB 220, and a function DB 230 exist on a server. The following gives examples of information that may be stored in each of these DBs.

The user DB 210 stores registered device information 211 and external service information 213 for each user, for example. In the example illustrated in FIG. 2, three instances of registered device information 211 for Device 1 to Device 3 are stored for a user with a UserID of 001. Since registered device information 211 is generated for each device that a user registers, in this case, the user with a UserID of 001 has registered three devices.

The registered device information 211 includes, for example, a Device ID for identifying the type of device, and a Utilized Function ID for identifying functions that the user actually utilizes using the device. The Device ID is shared in common with the Device ID assigned in the device information stored in the device DB discussed later. Consequently, it is possible to use a Device ID included in registered device information 211 to acquire device information corresponding to a device that a user has registered. The Utilized Function ID is shared in common with the Function ID assigned in the function information stored in the function DB discussed later. Consequently, it is possible to use a Utilized Function ID included in registered device information 211 to acquire function information for a function that a user actually utilizes.

Meanwhile, in the example illustrated in FIG. 2, external service information 213 for an External service 1 is stored for the user with a UserID of 001. The external service information 213 includes, for example, a Service name, an Account, and a Password. The Service name is information for identifying various services that a user utilizes, such as an SNS or other service, for example. The Account and Password is information used to log in to the external service. The server application 200 uses this information to specify a user's account on an external service, and acquire the user's activity log on the external service. It is possible to use a user's activity log to recommend linked functions and new devices to the user, for example.

Note that although the user DB 210 is disposed in a server in the present embodiment, in another embodiment the user DB 210 may be disposed on the client side, or in other words, disposed on the side of the owned devices 100. In this case, the server application 200 accesses owned devices 100 of the client as appropriate, and acquires information from the user DB 210.

The device DB 220 stores device information 221 for each device, for example. Device information 221 is registered by the manufacturer of each device, for example. The device information 221 includes, for example, a Device ID for identifying the type of device, a Model No, a Category, a Product name, and an Image. The Device ID is an ID shared in common with the Device ID included in the registered device information 211 of the user DB as above. With the Device ID, it is possible to identify the type of a device that a user has registered.

The Model No is a model number assigned to each device. The Category is a category for each device, such as smartphone, TV, or recorder, for example. The Product name is a product name assigned to each device. The Image is an image of each device. Since the Device ID is used to identify each device in the present embodiment, the Model No and subsequent information is used in order to specify a device from information such as text or an image input when the user registers a device, and is displayed in order to enable a user to more easily recognize a device using information such as a product name and image when providing device-related information to a user.

The function DB 230 stores function information 231 and later-discussed procedure information for each device, for example. Function information 231 is generated for each function realized by the linkage of multiple devices, such as “Throw” (a function that transfers photos from a mobile device to a TV) and “Mobile Transfer” (a function that transfers videos from a recorder to a mobile device), for example. Note that functions that are the subject of the function information 231 are not necessarily limited to functions realized by the linkage of multiple devices, and may also include functions realized by a single device, for example.

The function information 231 includes, for example, a Function ID, a Function name, Linked Device IDs, a Procedure ID, a Rating, Comments, and Conditions for recommendation. Besides being registered by the manufacturer of each device, the function information 231 may also be generated on the basis of user-provided information for a new link function discovered by a user, for example.

The Function ID is an ID for identifying each function. For example, different function IDs are assigned to functions having the same function name but different linked devices, and to functions having the same linked devices but different procedures. The Function name is displayed to enable a user to more easily recognize a function when providing function-related information to the user. The Linked Device IDs are device IDs of devices that link in order to realize a function. The ID of each device herein is shared in common with the Device ID in the device information 221 stored in the device DB 220. Consequently, it is possible to use the Linked Device IDs included in the function information 231 to reference device information for the devices that link in order to realize that function.

The Procedure ID is information indicating an operating procedure that the user executes in order to realize a function. In the present embodiment, information on each operating procedure is stored as procedure information discussed later, making it possible to use the Procedure ID information included in the function information 231 to reference procedure information for realizing that function. Herein, multiple Procedure IDs may be registered for a single function, as illustrated in FIG. 2. In other words, the function information 231 may include information indicating multiple procedures for realizing a single function.

The Rating is information on a user rating for a function. Although the example illustrated in FIG. 2 depicts a three-stage rating, the rating methodology is not limited thereto. The Rating is recorded and updated by the registration of a rating value from a user who has used the function, for example. Alternatively, the Rating may be automatically computed by counting the number of times a user has used the function, for example. Similarly, the Comments are information on user comments for a function, also referred to as word-of-mouth information. The Comments may also be a path to a storage location (such as a DB not illustrated) for comments contributed by users.

The Conditions for recommendation are information on conditions for recommending a function to a user. A system according to the present embodiment is capable of recommending a function to a user by analyzing factors such as the states of devices owned by the user, and device usage histories, for example. The Conditions for recommendation may also be device states, such as when a smartphone is storing 100 photos, when 15 programs have been recorded by a recorder, or when the playback of a recorded program is stopped partway through. In addition, a function recommendation may also be based on analysis of factors such as an SNS activity log, for example. The Conditions for recommendation may also be a path to a storage location (such as a DB not illustrated) for information on conditions for recommending such a function, for example.

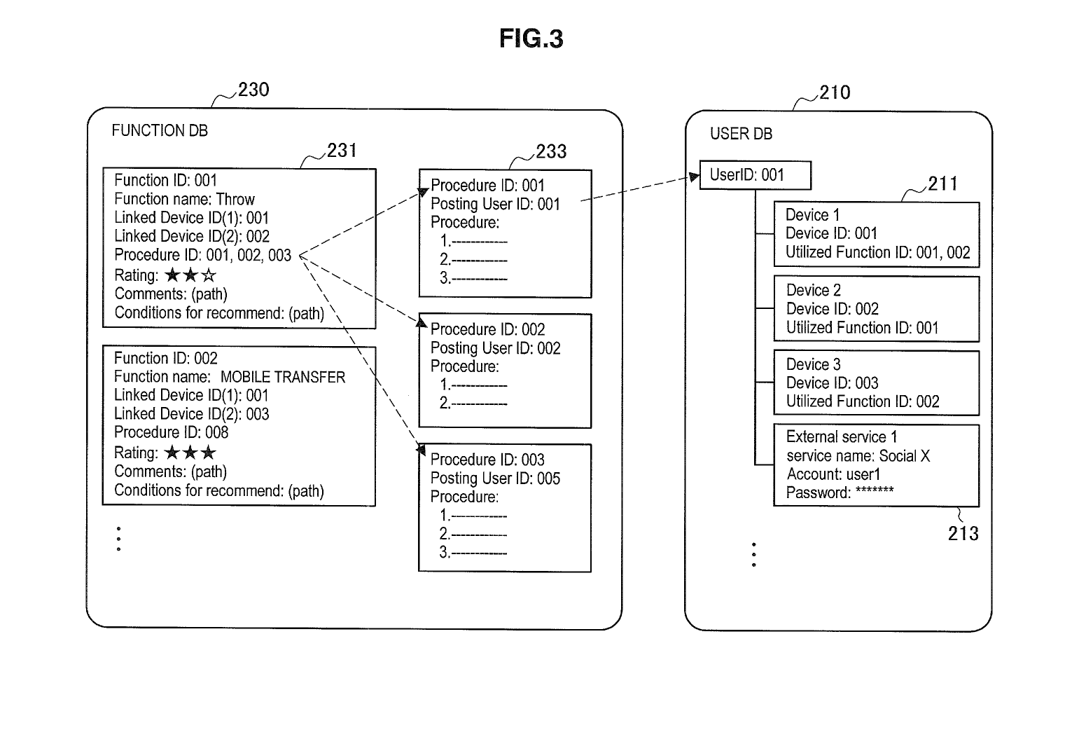

FIG. 3 is a diagram illustrating an example of procedure information according to an embodiment of the present disclosure. In the present embodiment, the function DB 230 may store procedure information 233 for each device. The procedure information 233 includes, for example, a Procedure ID, a Posting User ID, and a Procedure. Besides being registered by the manufacturer of each device, the procedure information 233 may also be generated on the basis of user-provided information for new a link function discovered by a user or a new procedure discovered by a user for an existing link function, for example.

The Procedure ID is an ID for identifying each procedure. Procedure ID information is also included in the function information 231. In the present embodiment, the basic flow of a procedure for realizing a given function involves referencing the procedure information 233 via the function information 231. In the example illustrated in FIG. 3, there exist three procedures having a Procedure ID of “001”, “002”, and “003”, respectively (hereinafter also referred to as the “procedures 001 to 003”) for a function having a Function ID of “001” in the function information 231 (hereinafter also referred to as the “function 001”). This indicates that there are three procedures (the procedures 001 to 003) that may be performed in order to realize the function 001. The function 001 is realizable by executing any of the procedures 001 to 003.

The Posting User ID is information indicating the user who registered a particular procedure. As above, besides being registered by the manufacturer of each device, the procedure information 233 may in some cases be generated on the basis of user-provided information. In such cases, a Posting User ID is recorded in order to indicate who posted procedure information 233. The user ID used as the Posting User ID is shared in common with the UserID in the user DB 210. Doing so enables centralized management of information such as which user owns which devices, executes which functions, and recorded which procedures, for example. Note that in the case where procedure information 233 is registered by a device manufacturer or the like, for example, another ID not used in the user DB 210 may also be recorded as the Posting User ID.

The Procedure is information indicating the specific details of an operating procedure. The information recorded as a Procedure may be text and image information provided to a user as a manual, program code causing a device to automatically execute configuration operations, or a combination of the above, for example. A Procedure registration method and specific examples of utilization methods will be discussed later.

Also, as another example, the function information 231 and the procedure information 233 may also be generated by analysis of an SNS log. For example, information related to functions and procedures may be extracted by syntax analysis or keyword extraction from text such as a user's review of a device posted to a community on the Internet, such as an SNS.

As described above, in an embodiment of the present disclosure, there exist a user DB 210, a device DB 220, and a function DB 230, which manage information such as relationships between users and devices (device registration), relationships between devices and functions (information on device linkage), and relationships between functions and users (utilized functions, and the registration of function procedures).

(1-3. Exemplary Functional Configuration)

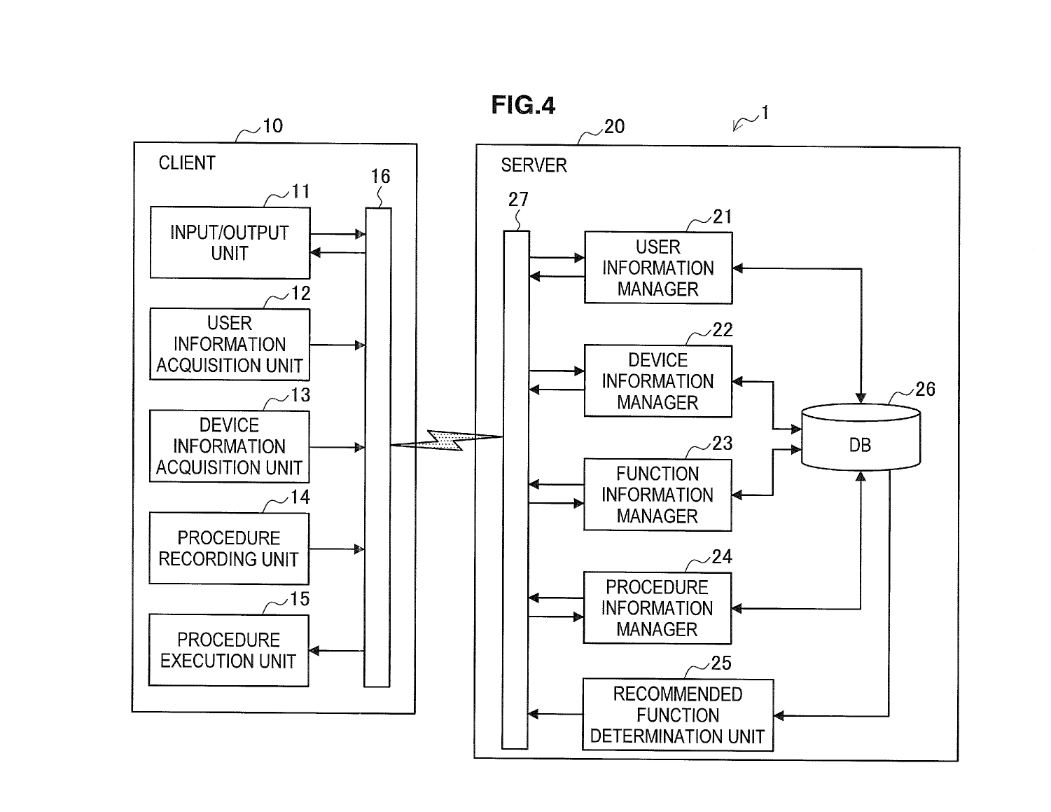

FIG. 4 is a diagram that schematically illustrates a functional configuration of a system according to an embodiment of the present disclosure. A system like that described above with reference to FIGS. 1 to 3 may be realized as a system 1, for example. The system 1 includes a client 10 and a server 20. The client 10 and the server 20 communicate with each other via a wired or wireless network.

(Client)

The client 10 may include at least part of the function of device registration and the function of receiving information from the server application 200 from among the owned devices 100 illustrated in FIG. 1, for example. In other words, in the case where the smartphone 100a from among the owned devices 100 registers the other owned devices 100b to 100e, for example, the smartphone 100a is the client 10. Also, in the case where the TV 100b receives information from the server application 200, the TV 100b is also the client 10. The client 10 may be realized using the hardware configuration of an information processing apparatus discussed later, for example.

As illustrated in FIG. 4, the client 10 includes an input/output unit 11, a user information acquisition unit 12, a device information acquisition unit 13, a procedure recording unit 14, a procedure execution unit 15, and a communication unit 16.

The input/output unit 11 is realized by an output device, such as a display or speakers, and an input device, such as a mouse, keyboard, or touch panel. The input/output unit 11 outputs information to a user, and also accepts user operations. The input/output unit 11 displays a user interface (UI) like the display screen examples discussed later, for example, and accepts user input operations with respect to the display screens. Displayed operation screens may include recommendation information and procedure information.

The user information acquisition unit 12, the device information acquisition unit 13, the procedure recording unit 14, and the procedure execution unit 15 are realized by a processor such as a central processing unit (CPU). The user information acquisition unit 12 acquires information related to the user him- or herself who uses the client 10, and transmits the acquired information to the server 20 via the communication unit 16. The information acquired by the user information acquisition unit 12 may include user account information for utilizing a service according to an embodiment of the present disclosure, for example. Furthermore, the user information acquisition unit 12 may acquire account information for an SNS utilized by a user. SNS account information transmitted to the server 20 is registered as external service information 213 in the user DB 210, for example.

The device information acquisition unit 13 acquires information related to the above owned devices 100 or non-owned devices 110, and transmits the acquired information to the server 20 via the communication unit 16. As discussed later, the information acquired by the device information acquisition unit 13 may include various information for the purpose of identifying a device at the server 20, such as a model number for each device, an image of each device taken by the user, an infrared waveform from a controller for each device, a user ID registered in association with a device, or information for identifying each device detected in accordance with a standard such as DLNA (registered trademark). This information is transmitted to the server 20 during the device registration process, for example. Furthermore, the device information acquisition unit 13 may also acquire and transmit to the server 20 information indicating device states for already-registered owned devices 100. The information transmitted at this point may be information indicating that a smartphone is storing 100 photos, that 15 programs have been recorded by a recorder, or that playback of a recorded program is stopped partway through, for example, and is compared to the conditions for recommendation for each function at the server 20, as discussed later.

The procedure recording unit 14 records information indicating an operating procedure that is executed when a user uses some function, and transmits the recorded information to the server 20 via the communication unit 16. The information recorded by the procedure recording unit 14 may include various operation logs for operations such as, for example, input operations performed on the client 10 using a mouse, keyboard, or touch panel included in the input/output unit 11, cable connections, and recording media insertions or removals (such logs may not only include operations actively executed by the user, but also behaviors executed by a device as a result thereof). In addition, the procedure recording unit 14 may also be capable of acquiring operation logs from other devices connected to the client 10 via a network.

The procedure execution unit 15 causes the client 10 to automatically execute an operating procedure in accordance with program code that the communication unit 16 receives from the server 20. The program code received from the server 20 may program code for causing the client 10 to execute an operating procedure that was executed when another user used a function. Furthermore, the procedure execution unit 15 may also be capable of causing other devices connected to the client 10 via a network to automatically execute an operating procedure. Note that an operating procedure for realizing a function that links devices may not necessarily be complete through automatic execution by the procedure execution unit 15. For example, when a information such as particular content is selected by a user's input operation, or when actions such as cable connections and recording media insertions or removals are carried out manually by a user, the procedure execution unit 15 may temporarily stop the automatic execution of a procedure, and output via the input/output unit 11a message requesting an operation to be performed by the user.

The communication unit 16 is realized by a communication device for the purpose of communicating with the server 20 via various wired or wireless networks, or by an interface to such a communication device. The communication unit 16 transmits information acquired by the respective units above to the server 20, and also receives, from the server 20, recommendation information recommending functions realized by the linkage of devices to a user, and procedure information indicating an operating procedure for realizing a function that the user has selected from among the functions recommended by the recommendation information. Herein, the functions recommended by the recommendation information may be functions for which the information indicating the states of the owned devices 100 transmitted by the device information acquisition unit 13 satisfies given conditions for recommendation, for example. Alternatively, the recommended functions may be functions used by friends of a user on an SNS detected on the basis of the user's SNS account information acquired by the user information acquisition unit 12. Also, the recommended functions may be functions with updated information on the server 20, such as newly added functions, for example.

In addition, the procedure information received by the communication unit 16 may also be information explaining an operating procedure with text or images, for example. An operating procedure described herein may be registered by a device manufacturer or the like, and may also be a recording of a procedure that another user executed when using a function. Alternatively, the procedure information may be program code by which the procedure execution unit 15 causes a device such as the client 10 to automatically execute an operating procedure. The program code described herein may be registered by a device manufacturer or the like, and may also be a recording of a procedure that another user executed when using a function. Procedure information may also be a combination of program code and information explaining an operating procedure. In this case, the part of a procedure that is independently executable by a device such as the client 10 may be automatically executed by program code, while information explaining an operating procedure with images, text, or the like may be displayed via the input/output unit 11 for the part of a procedure that involves user actions, such as connecting devices or selecting content.

Note that, as discussed above, the registration of devices and the receiving of information may not necessarily be executed by the same device. Consequently, a client 10 may include all, or only some, of the structural elements from the user information acquisition unit 12 to the procedure execution unit 15.

(Server)

The server 20 is the server 20 that includes the server application 200, the user DB 210, the device DB 220, and the function DB 230 illustrated in FIG. 1, for example. The server 20 may be realized by a single server device, and may also be realized by multiple server devices connected via a wired or wireless network and cooperating together. The individual server devices may be realized using the hardware configuration of an information processing apparatus discussed later, for example.

As illustrated in FIG. 4, the server 20 includes a user information manager 21, a device information manager 22, a function information manager 23, a procedure information manager 24, a recommended function determination unit 25, a DB 26, and a communication unit 27.

The user information manager 21, the device information manager 22, the function information manager 23, the procedure information manager 24, and the recommended function determination unit 25 are realized by a processor such as a CPU. The user information manager 21 primarily manages information stored in the above user DB 210 (included in the DB 26). For example, the user information manager 21 registers information received from a client 10 via the communication unit 27 in the user DB 210. The information to be registered may include information such as registered device information 211 associating owned devices 100 or non-owned devices 110 with a user, and external service information 213 that includes account information for an external service such as an SNS used by a user. Also, the user information manager 21 may acquire information indicating the states of registered owned devices 100 from a client 10 via the communication unit 27. This information may be retrieved by the recommended function determination unit 25 after being recorded in the DB 26, as discussed later, or provided to the recommended function determination unit 25 from the user information manager 21 without going through the DB 26.

The device information manager 22 primarily manages information stored in the above device DB 220 (included in the DB 26). For example, the device information manager 22 retrieves device information 221 registered by a device manufacturer or the like as appropriate, and provides the retrieved information to the function information manager 23, the procedure information manager 24, and the recommended function determination unit 25.

The function information manager 23 primarily manages function information 231 stored in the above function DB 230 (included in the DB 26). For example, the function information manager 23 updates function information 231 on the basis of information received from a client 10 via the communication unit 27. Items to be updated may include a rating for a function by a user who has used that function. In this case, the function information manager 23 updates the Rating item included in the function information 231, for example. In the case where the rating value indicated by the Rating item exceeds a given threshold value due to being updated, that function may become the subject of a recommendation by the recommended function determination unit 25. Alternatively, the function information manager 23 may acquire information indicating that a user has used a function, and update an item in the function information 231 indicating a count of the number of times that function has been executed (not illustrated in FIGS. 2 and 3). In the case where the count exceeds a given threshold value due to being updated, that function may become the subject of a recommendation by the recommended function determination unit 25.

Furthermore, the function information manager 23 may also register new function information 231 on the basis of information received from a client 10 via the communication unit 27. As discussed later, it is also possible for a user to use a client 10 to register a new function when registering an operating procedure for realizing a function. In this case, since function information 231 does not exist for that function, the function information manager 23 registers new function information 231. At this point, the function information manager 23 checks whether or not the function attempting to be registered overlaps with an existing function, and registers new function information 231 if the function does not overlap.

The procedure information manager 24 primarily manages procedure information 233 stored in the above function DB 230 (included in the DB 26). For example, the procedure information manager 24 acquires, from the function DB 230, procedure information 233 indicating an operating procedure for realizing a function that the user has selected from among recommended functions determined by the recommended function determination unit 25, and transmits the acquired information to a client 10 via the communication unit 27. The procedure information acquired and transmitted at this point may also be information explaining an operating procedure with text, images, or the like, for example. In this case, a user receiving procedure information on a client 10 executes the operating procedure manually while referring to the explanation. Alternatively, the procedure information may be program code for causing a device to execute an operating procedure. In this case, the client 10 receiving the procedure information or another device connected to the client 10 via a network uses the program code to automatically execute the operating procedure.

Furthermore, the procedure information manager 24 may also register new procedure information 233 on the basis of information received from a client 10 via the communication unit 27. As discussed later, it is possible for a user to use a client 10 to register an operating procedure for realizing a function. The information provided by a client 10 may be operation logs from when a user executed an operating procedure, for example. The procedure information manager 24 may convert this information into an explanation using text or images and register the converted information as procedure information 233, and may also convert the information into program code for causing a device to execute an operating procedure, and register the converted program code as procedure information 233. At this point, the procedure information manager 24 checks whether or not the procedure attempting to be registered overlaps with an existing procedure, and registers new procedure information 233 if the procedure does not overlap.

Herein, in some cases, multiple procedures may be registered for a function, for example. For example, in the example in FIG. 3, three procedures corresponding to the Procedure IDs 001, 002, and 003 are registered for a function with a Function ID of 001. Because of such cases, the procedure information manager 24 may also acquire from a client 10 a count indicating the number of times a user has executed a procedure. The count of the number of times a user has executed a procedure may be recorded as procedure information 233 (not illustrated in the example in FIG. 3). In this case, when providing procedure information to another user, the procedure information manager 24 selects procedure information 233 with a larger recorded count.

The recommended function determination unit 25 determines recommended functions to recommend to a user on the basis of information stored in the DB 26. Information on recommended functions is transmitted to a client 10 via the communication unit 27. A user selects a function to use from among the recommended functions. The selection result is transmitted from the client 10 to the server 20, and on the basis of this result, the procedure information manager 24 specifies a function for which to provide procedure information to the user. Recommended functions may be determined on the basis of registered device information 211 stored in the user DB 210 and function information 231 stored in the function DB 230, for example. Combining registered device information 211 and function information 231 enables the specification of functions realizable by the linkage of devices that a user owns or is considering owning. By recommending such functions to a user, functions that are more useful to the user are recommended.

For example, when the user DB 210 or the function DB 230 included in the DB 26 are updated, the recommended function determination unit 25 may also determine recommended functions and transmit that information to a client 10. More specifically, the above may occur when a new device is registered as registered device information 211, or when a new function is registered as function information 231. By receiving recommendations for functions in such cases, a user is able to more quickly acquire information related to functions that may be newly utilized, and make use of such functions, for example.

Also, when information indicating the rating or execution count for a function is updated in the function DB 230 included in the DB 26, the recommended function determination unit 25 may also determine recommended functions and transmit that information to a client 10. More specifically, when the rating value for a function exceeds a given threshold value, or when the execution count for a function exceeds a given threshold value, that function may be assumed to be a popular function, and be recommended to a user.

In addition, in the case where the states of a user's owned devices acquired by the user information manager 21 satisfy the Conditions for recommendation for a particular function stored as function information 231 in the function DB 230, the recommended function determination unit 25 may recommend that function to the user. As discussed earlier, the device states used at this point may be states such as when a smartphone is storing 100 photos, when 15 programs have been recorded by a recorder, or when the playback of a recorded program is stopped partway through, for example. Thus, when a function becomes particularly useful for a user, that user is able to receive a recommendation for that function, thereby improving usability for the user receiving the function recommendation.

Alternatively, the recommended function determination unit 25 may acquire a user's SNS account information from external service information 213 included in the user DB 210, and determine a function to be a recommended function when a user's friend on the SNS uses that function. As another example that similarly utilizes an SNS, the recommended function determination unit 25 may record function ratings and execution counts limited to a user's friends on an SNS, and determine a function with a high rating or high execution count among friends to be a recommended function.

The DB 26 is realized by a storage device, for example. The DB 26 includes data corresponding to the above user DB 210, device DB 220, and function DB 230, for example. Note that the structure of the DB may be arbitrarily designed, and the above three DBs may not necessarily be set insofar as data relevant to providing information to a user is still stored. All DBs included in the DB 26 may be realized by the same device, or by respectively different devices.

The communication unit 27 is realized by a communication device for the purpose of communicating with a client 10 via various wired or wireless networks, or by an interface to such a communication device. The communication unit 27 transmits information generated by the procedure information manager 24 and the recommended function determination unit 25 to a client 10, and also provides information received from a client 10 to the user information manager 21, the device information manager 22, the function information manager 23, or the procedure information manager 24.

(2. Device Registration Process)

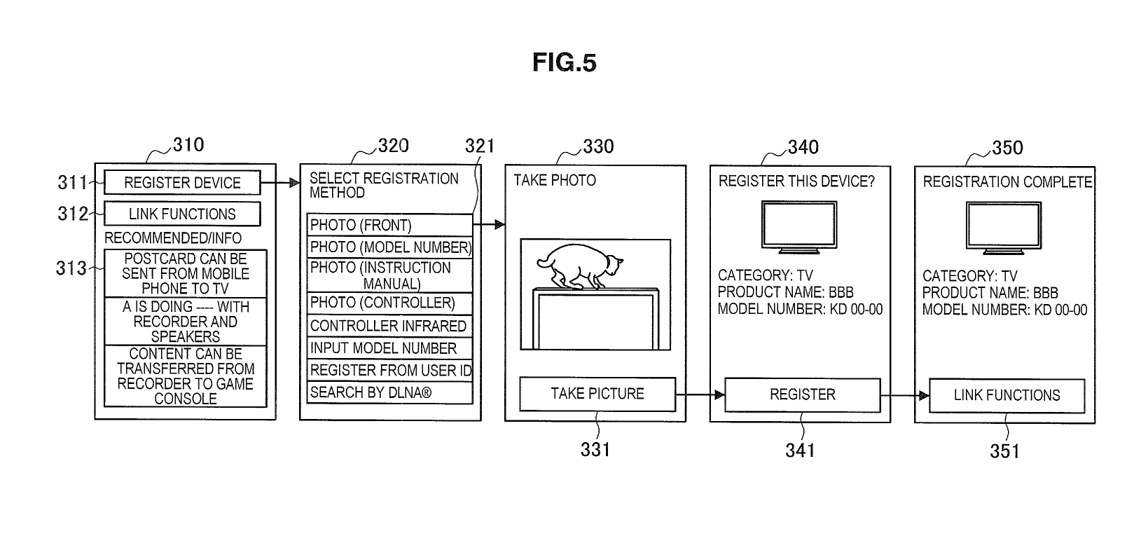

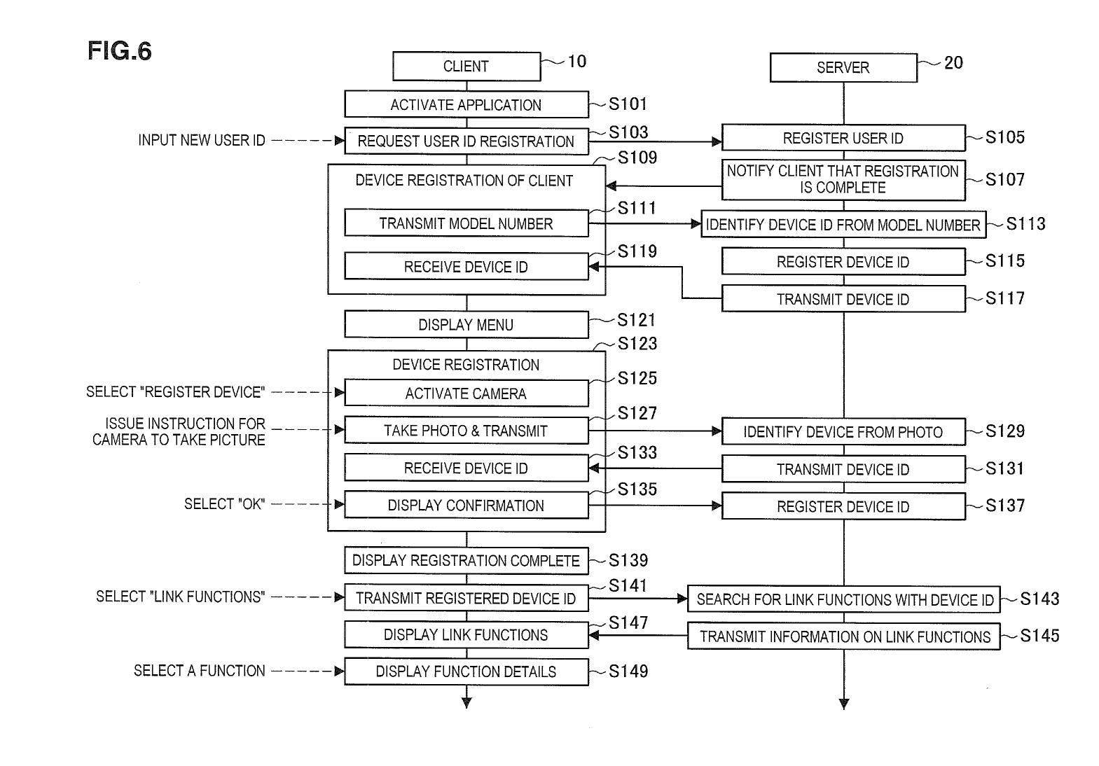

Next, a device registration process according to an embodiment of the present disclosure will be described with reference to FIGS. 5 and 6.

As discussed above, in a system according to an embodiment of the present disclosure, it is possible to register devices owned by a user in the system. It is also possible to register devices that a user does not own, such as a device that a user plans to purchase or a device that a user is considering purchasing, for example.

In the case of not conducting such device registration, there is a possibility that the user may not even be aware that there are functions realizable by device linkage, for example. Also, although information is provided by instruction manuals, catalogs, and the like, the functions described therein also include link functions with devices not owned by the user, and since there is too much information, obtaining information regarding suitable functions is difficult. Furthermore, although searching for descriptions of functions on the Web has become typical in recent years, if the particular desired function is not specified, a user will not know appropriate search keywords, thus making it difficult to obtain information regarding suitable functions.

Thus, an embodiment of the present disclosure provides a function that registers devices that a user owns (and devices that the user plans to own) in a system. In so doing, devices utilizable by a user (including devices expected to become utilizable) may be ascertained on the system side, making it possible to determine what link functions are realizable by the devices that a user owns currently or will own in the future. Providing a user with information targeting realizable link functions makes it possible for the user to easily obtain information regarding suitable functions, without too much information. Consequently, a user is able to make full use of convenient functions in his or her devices. Moreover, there is a possibility that registering devices that the user does not currently own in the system and giving the user detailed information regarding link functions will lead to purchases.

FIG. 5 is a diagram illustrating an example of display screens in a device registration process according to an embodiment of the present disclosure. In the example illustrated in FIG. 5, a menu screen 310 is displayed when an application is activated on a client 10. Displayed on the menu screen 310 are a device registration button 311, a link function button 312, and notification information 313. At this point, assume that a user selects the device registration button 311. Note that the notification information 313 may display information such as information on functions recommended to the user, for example.

Next, a registration method selection screen 320 is displayed. On the registration method selection screen 320, the user selects a desired registration method from among registration method options 321. Herein, the registration methods displayed as the registration method options 321 may differ depending on the input capabilities of the client 10. In the example illustrated in FIG. 5, there are displayed four registration methods that use photos (involving a camera), a registration method that uses infrared (involving an infrared signal receiver), two registration methods that use text input (involving text input medium such as a keyboard or touch panel), and a registration method that uses DLNA (registered trademark) (involving a device that supports DLNA (registered trademark)). However, not all of these registration methods may be utilizable by all clients 10. For example, the registration methods that uses photos are not displayed in the case of a client 10 not equipped with a camera, while the registration method that uses DLNA (registered trademark) is not displayed in the case of a client 10 that does not support DLNA (registered trademark).

Examples of registration methods will now be described in further detail. In the example illustrated in FIG. 5, four registration methods that use photos are displayed. More specifically, “Photo (front)”, “Photo (model number)”, “Photo (instruction manual)”, and “Photo (controller)” are displayed. “Photo (front)” is a method that takes a photo of a device's main case or housing, and specifies the depicted device by image analysis from the photo. “Photo (model number)” is a method that takes a photo of a model number displayed on a device, and uses technology such as optical character recognition (OCR) to read the model number therefrom. Note that the information corresponding to a model number (such information may also be a product code or the like used in the distribution process) may also not be displayed as text, and instead may be displayed as a barcode or 2D code, for example.

“Photo (instruction manual)” is a method that takes a photo of a device's instruction manual, and specifies the depicted instruction manual by image analysis of the photo, or specifies a device by using OCR or other technology to read text stated in the instruction manual. “Photo (controller)” is a method that takes a photo of a device's controller (such as a remote control), and specifies the device to which the controller belongs from the button layout and displayed characters.

Additionally, in the example illustrated in FIG. 5, a registration method that uses “Controller infrared” is displayed. This is a method that acquires an infrared waveform emitted from a device's controller, and specifies the device by cross-referencing against waveforms unique to each device. “Input model number” is a method that specifies a device by direct textual input of a device's model number. “Register from user ID” is a method that, in the case where user registration is conducted at the time of purchasing a device, for example, specifies a device owned by the user from information on a registered user. “Search by DLNA (registered trademark)” uses the Digital Living Network Alliance (DLNA; registered trademark) protocol to search for a device connected by a network to a client 10. However, this method is not limited to DLNA (registered trademark), and a protocol of another standard related to linkage among devices may also be used for searching.

Herein, assume that a user selects “Photo (front)”. A photo imaging screen 330 is then displayed. On the photo imaging screen 330, imaging is executed by selecting a “Take picture” button 331. An imaged photo is transmitted to the server 20, and the device depicted in the photo is specified by matching against images of respective devices stored as device information.

Once a device is specified, a registration confirmation screen 340 is displayed. Displayed on the registration confirmation screen 340 is information enabling a user to check the device to be registered, such as an image of the device and the device category, product name, and model number, for example. On the registration confirmation screen 340, registration is executed by selecting a Register button 341.

Once registration of a device is executed, a registration complete screen 350 is displayed. A link function buttons 351 may also be displayed on the registration complete screen 350. If the link functions button 351 is selected, the device registered by the processing up to this point is used to start a search process for realizable link functions.

FIG. 6 is a diagram illustrating an example of a process flow in a device registration process according to an embodiment of the present disclosure. FIG. 6 illustrates a process for the case where an application is activated on a client 10 for the first time (steps S101 to S149). Note that when the application is activated for a second and subsequent times, the processing for user ID registration and device registration for the client (steps S103 to S119) is skipped.

First, an application is activated on a client 10 (step S101). If a new user ID is input via the input/output unit 11, the client 10 requests user ID registration from the server 20 (step S103). At the server 20, the user information manager 21 registers the user ID in the DB 26 (step S105), and notifies the client 10 that registration is complete (step S107).

Upon receiving a notification that user ID registration is complete, the client 10 subsequently executes device registration for the client 10 (step S109). Since the client 10 is certainly a device that the user owns, automatically registering the client 10 as an owned device 100 is convenient for the user. At this point, the device information acquisition unit 13 internally acquires the model number of the client 10, and transmits the acquired model number to the server 20 (step S111).

At the server 20, the device information manager 22 uses the received model number to reference device information stored in the DB 26, and identifies a device ID (step S113). The user information manager 21 registers the identified device ID in the DB 26 (step S115). More specifically, the user information manager 21 adds registered device information for the user stored in the DB 26.

Meanwhile, the identified device ID may also be transmitted to the client 10 (step S117). After receiving the device ID (step S119), the client 10 may thereby recognize that device registration for the client 10 is complete and start the next process, and may also register the device ID in a DB in the client 10. As discussed earlier, the user DB 210 may be disposed in the client 10, and may also be disposed in both the server 20 and the client 10. In the case where the client 10 includes the user DB 210, registered device information for the user is added using the received device ID.

Next, a menu screen is displayed on the client 10 (step S121). The menu displayed at this point may be one like the menu screen 310 illustrated in FIG. 5, for example. At this point, a device registration process (step S123) is started if the user selects the execution of device registration. The example illustrated in FIG. 6 assumes that the execution of device registration using a photo is selected.

In the device registration process, first the device information acquisition unit 13 activates a camera in the client 10 (step S125). The camera takes a photo according to imaging instructions from the user. The device information acquisition unit 13 acquires image data of the imaged photo, and transmits the acquired image data to the server 20 (step S127). At the server 20, the device information manager 22 matches the received image data against images in the device information stored in the DB 26, and identifies the device ID of a device to register (step S129). Note that although a device ID is identifies from the image data of a photo in the example illustrated in FIG. 6, it is also possible for a device ID to be similarly identifies by various other methods, as indicated by the registration method selection screen 320 in FIG. 5, for example.

The identified device ID is transmitted to the client 10 (step S131), and the client 10 receiving the identified device ID (step S133) displays a confirmation screen (step S135). The confirmation screen may be one like the registration confirmation screen 340 illustrated in FIG. 5, for example. At this point, if the user indicates OK, or in other words selects the execution of registration, a registration execution request is transmitted from the client 10 to the server 20, and the user information manager 21 registers the device ID in the DB 26 (step S137). More specifically, the user information manager 21 adds registered device information for the user stored in the DB 26. The device ID may also be registered on the client 10 side, similarly to the case of the device ID registration in step S115.

Once registration of the device ID is complete, a registration complete screen is displayed on the client 10 (step S139). The registration complete screen may be one like the registration complete screen 350 illustrated in FIG. 5, for example.

As supplementary processing after device registration, an application similar to that in the client 10 may also be installed in the registered device. In this case, there is a high likelihood that the client 10 that registered the device and the registered device are different types of devices, and thus the type of application to install also differs (such as in the case of registering a TV with a smartphone, for example). Thus, the server 20 selects and installs a type of application suited to the registered device.

If at this point the user selects the display of link functions (such as by selecting the link functions button 351 illustrated in FIG. 5, for example), a link function display process starts. The client 10 transmits to the server 20 the device ID received in step S133, or in other words the device ID that was registered in the immediately previous device registration process (step S141).

At the server 20, the device information manager 22 references a device DB stored in the DB 26, and searches for a link function realizable with the device in question (step S143). At this point, the user information manager 21 may additionally reference a user DB and search for a link function realizable with the device in question and another device that the user has registered. Information on one or more link functions found by search is transmitted from the server 20 to the client 10 (step S145).

At the client 10, the received information on one or more link functions is displayed (step S147). The display at this point may be a list display in the case of multiple link functions, for example. If the user selects a link function, details of that link function (such as which devices are linked and what is accomplished, for example) are displayed (step S149). Herein an example of a display related to a link function will be discussed later.

(3. Procedure Registration Process)

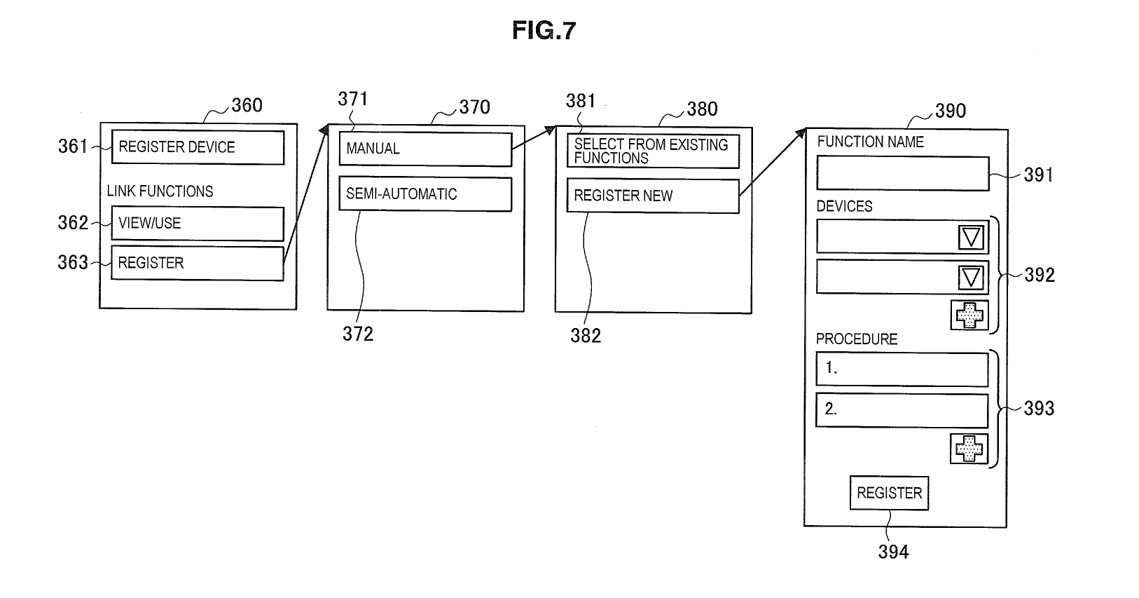

Next, a procedure registration process according to an embodiment of the present disclosure will be described with reference to FIGS. 7 to 11.

In a system according to an embodiment of the present disclosure, it is not only possible for a user to register a device, but also a function, as well as a procedure for realizing a function. The registration of functions and procedures herein is intended to complement information related to functions and procedures registered in a server in advance by device manufacturers or the like, for example (in other words, information like in an instruction manual) with information registered by users.

An instruction manual provided on a paper medium or as a Web page is provided by a device manufacturer, for example. An instruction manual is suitable for obtaining comprehensive information related to a device. On the other hand, however, information on link functions may be stated abstractly since the linking device is unidentified, and functions not recognized on the manufacturer's side may not be described, for example. Thus, an instruction manual may not necessarily be an easy-to-use information source for a user in some cases.

In contrast, since information on functions and procedures registered by users has been actually executed with a specific combination of a user's devices, the information is stated specifically. Also, even if a function has not been recognized on the manufacturer side, if a user who has discovered the function registers a procedure, a procedure for realizing that function may be shared with other users.

In the following description, three examples of procedure registration processes will be described: manual, semi-automatic, and automatic. With a manual procedure registration process, a user registers information stated using text, images, or the like. In this case, information on a procedure to be registered may be information similar to an instruction manual or to information published on a blog on the Web or the like, for example. However, since the devices to be linked are identified and information on the devices (device IDs) are associated with information in the system during registration, a user referencing such information is able to easily find procedure information from a combination of owned devices.

Meanwhile, with semi-automatic and automatic procedure registration processes, operation logs for operations that a user executed with respect to a device is registered as information indicating a procedure. Registered procedure information may be provided to other users as operation logs converted into text or images, for example. In this case, rather than a procedure recognized by a user, an executed procedure is recorded directly, and thus there is no missing information, and it is easy for another user to execute the procedure by following the recorded information. In addition, registered procedure information may also be provided to another user as program code causing a device to automatically execute a similar operation. In this case, with a procedure execution process discussed later, another user is able to cause a device to automatically execute an operation such as configuring settings for device linkage.

Hereinafter, the three examples of manual, semi-automatic, and automatic will be described in further detail.

FIG. 7 is a diagram illustrating an example of display screens in a procedure registration process (manual) according to an embodiment of the present disclosure. In the example illustrated in FIG. 7, a menu screen 360 different from the earlier example in FIG. 5 is displayed. Displayed on the menu screen 360 are a device registration button 361, a view/use function button 362, and a function registration button 363. At this point, assume that a user selects the function registration button 363. Note that the device registration button 361 is a button for starting a device registration process similar to the example in FIG. 5, while the view/use function button 362 is button for starting a procedure execution process discussed later.

Next, a registration method selection screen 370 is displayed. On the registration method selection screen 370, the user selects a desired procedure registration method using a manual button 371 and a semi-automatic button 372. At this point, assume that the user selects the manual button 371. In this case, procedure registration is executed due to the user manually inputting a procedure, as described hereinafter. Note that the procedure registration process in the case of selecting the semi-automatic button 372 will be discussed later.

When a registration method is selected on the registration method selection screen 370, a function selection screen 380 is displayed in both the manual and semi-automatic cases. On the function selection screen 380, the user selects a function registration method using an existing function selection button 381 and a new registration button 382. The user selects the existing function selection button 381 in cases such as registering a new procedure for an already-existing function, for example. On the other hand, the user selects the new registration button 382 in cases such as registering a new function together with a procedure for that function. At this point, assume that the user selects the new registration button 382.

In the example illustrated in FIG. 7, a user has selected “manual registration” for the procedure registration method and “register new” for the function registration method, and thus a manual procedure registration method screen 390 is displayed for a new function. Displayed on the manual procedure registration method screen 390 are a function name input section 391, a device input section 392, a procedure input section 393, and a registration button 394.

The function name input section 391 is a text input field like that illustrated in FIG. 7, for example, and enables a user to input an arbitrary function name.

The device input section 392 is a list-type input field like that illustrated in FIG. 7, for example, and enables a user to specify devices used for a function. It is possible to specify devices by searching among partial model numbers or model names, searching among photos of devices, or searching among owned devices that a user has registered, for example. It is also possible to specify an arbitrary number of devices in the device input section 392, and a button that increases the number of items in the list (illustrated as a + button in FIG. 7) may also be displayed, for example.

The procedure input section 393 likewise is a list-type input field like that illustrated in FIG. 7, for example, and enables a user to record a procedure for realizing a function. A procedure may be recorded by text input into each input field, and may also be recorded using images, such as by attaching a file in each input field, for example. Likewise, it is possible to input a procedure with an arbitrary number of steps in the procedure input section 393, and a button that increases the number of items in the list (illustrated as a + button in FIG. 7) may also be displayed, for example. When input is complete and a user selects the registration button 394, the input function, device, and procedure are registered.

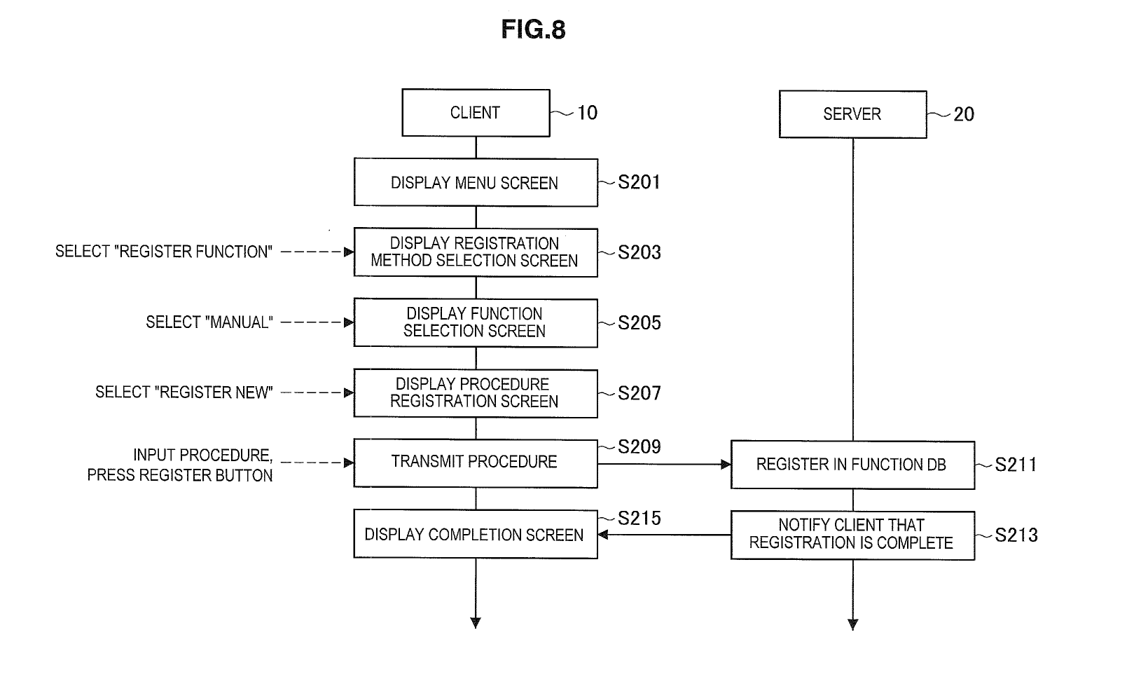

FIG. 8 is a diagram illustrating an example of a flow of the process illustrated in FIG. 7. First, the menu screen 360 is displayed on the client 10 (step S201). At this point, the registration method selection screen 370 is displayed if the user selects the device registration button 361 (step S203). At this point, the function selection screen 380 is displayed if the user selects the manual button 371 (step S205). In addition, the manual procedure registration method screen 390 is displayed if the user selects the new registration button 382 (step S207).

At this point, the user uses the function name input section 391, the device input section 392, and the procedure input section 393 displayed on the manual procedure registration method screen 390 to input a function, devices that link to realize the function, and a procedure for realizing the function. In the client 10, the procedure recording unit 14 records the input information. When the user selects the registration button 394, the procedure recording unit 14 transmits information on the recorded procedure to the server 20 (step S209).

At the server 20, the function information manager 23 processes the received procedure information. More specifically, the function information manager 23 registers information corresponding to the received procedure in the function DB 230 (step S211). Since a procedure for a new function is being registered in the above example, first, the function information manager 23 adds new function information 231 to the function DB 230. The function information manager 23 assigns a Function ID to the new function, and sets a Function name in the function information 231 according to the information input into the above function name input section 391. Also, the function information manager 23 sets one or more Linked Device IDs in the function information 231 according to the information input into the device input section 392.

Furthermore, the function information manager 23 adds new procedure information 233 to the function DB 230. The function information manager 23 assigns a Procedure ID to the new procedure, and in addition, sets this Procedure ID in the function information 231 for the new function. The function information manager 23 also sets the user ID of the user that transmitted the information as the Posting User ID in the procedure information 233. The function information manager 23 records a Procedure in the procedure information 233 according to the information input into the procedure input section 393.

When a registration process like the above ends, a registration completion notification is issued from the server 20 to the client 10 (step S213). At the client 10 that has received the registration completion notification, a completion screen (not illustrated in FIG. 7) is displayed (step S215).

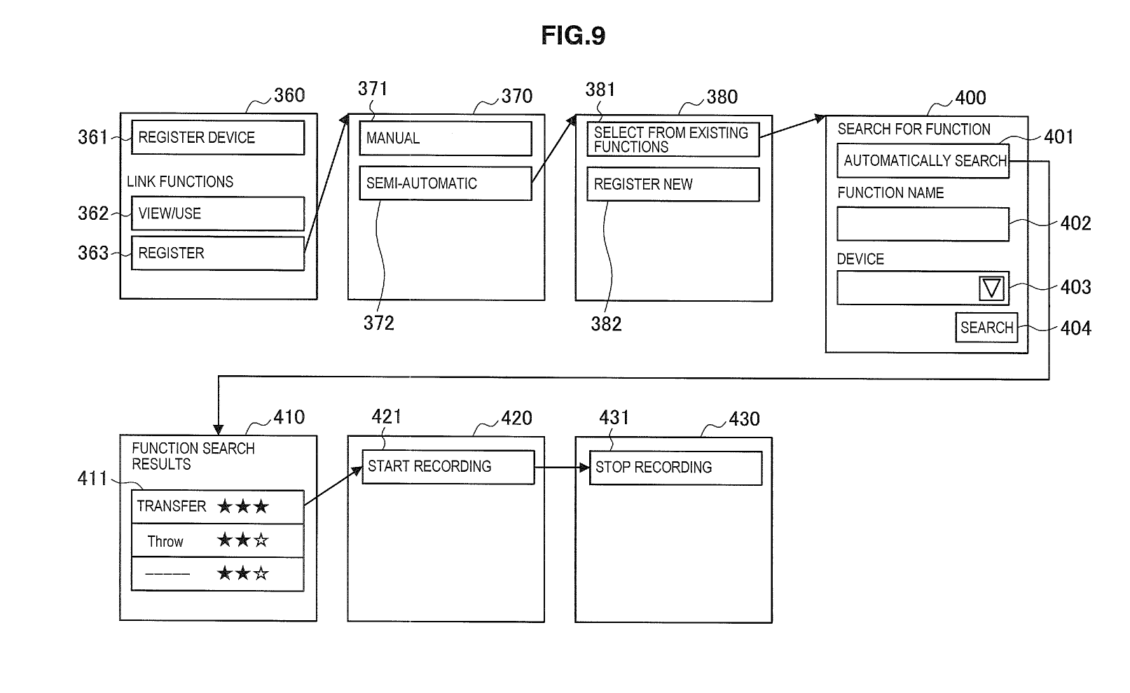

FIG. 9 is a diagram illustrating an example of display screens in a procedure registration process (semi-automatic) according to an embodiment of the present disclosure. In the example illustrated in FIG. 9, a menu screen 360, a registration method selection screen 370, and a function selection screen 380 are displayed, similarly to the above example in FIG. 7. However, this example differs from the example in FIG. 7 in that the user selects the semi-automatic button 372 on the registration method selection screen 370, and selects the existing function selection button 381 on the function selection screen 380.

As a result, a function search screen 400 is displayed next after the function selection screen 380. Displayed on the function search screen 400 are an automatic search button 401, a function name input section 402, a device input section 403, and an ordinary search button 404.

The automatic search button 401 is a button selected in the case of automatically searching for executable functions. Herein, functions realized by the linkage of the client 10 and another device registered by the user may also be searched for, for example. As another example, in cases such as where the procedure registration method is “manual registration”, functions realized by linkage between devices not including the client 10 from among the devices registered by a user may also be searched for.

The function name input section 402 includes an input field for inputting part or all of a function name in order to search. Also, the device input section 403 includes an input field for specifying some of all linked devices in order to search (although there is one field in the device input section 403 in the example illustrated in FIG. 9, multiple fields may also be displayed like the device input section 392 in the example in FIG. 7). When the ordinary search button 404 is selected, a search for functions is executed, taking either or both of the function name and one or more devices input via the function name input section 402 and the device input section 403 as parameters.

The results of a function search executed by selecting either the automatic search button 401 or the ordinary search button 404 are displayed as a function list 411 on a search results screen 410. The function names of the search results are displayed on the function list 411, for example. Also, ratings for the functions of the search results may also be displayed on the function list 411, as in the example illustrated in FIG. 9. In this case, the function list 411 may also be sorted in order of the highest ratings, for example.

In the case where the user selects one of the functions displayed on the function list 411 on the search results screen 410, a recording start screen 420 is displayed. The recording of a procedure is started as a result of the user selecting a start button 421 displayed on the recording start screen 420.

With the semi-automatic registration of a procedure in the present embodiment, there are recorded various operation logs for operations that the user executes after selecting the start button 421, such as input operations, cable connections, and recording media insertions or removals, for example (such logs may not only include operations actively executed by the user, but also behaviors executed by a device as a result thereof). Operation logs are recorded for at least the client 10. Also, if there is a device connected to the client 10 via a network among the other devices to be linked, operation logs for that device may also be acquired.

When the recording of a procedure starts, a recording screen 430 is displayed on the client 10. When an operating procedure for device linkage ends, the recording of the procedure is stopped as a result of the user pressing a stop button 431 displayed on the recording screen 430.

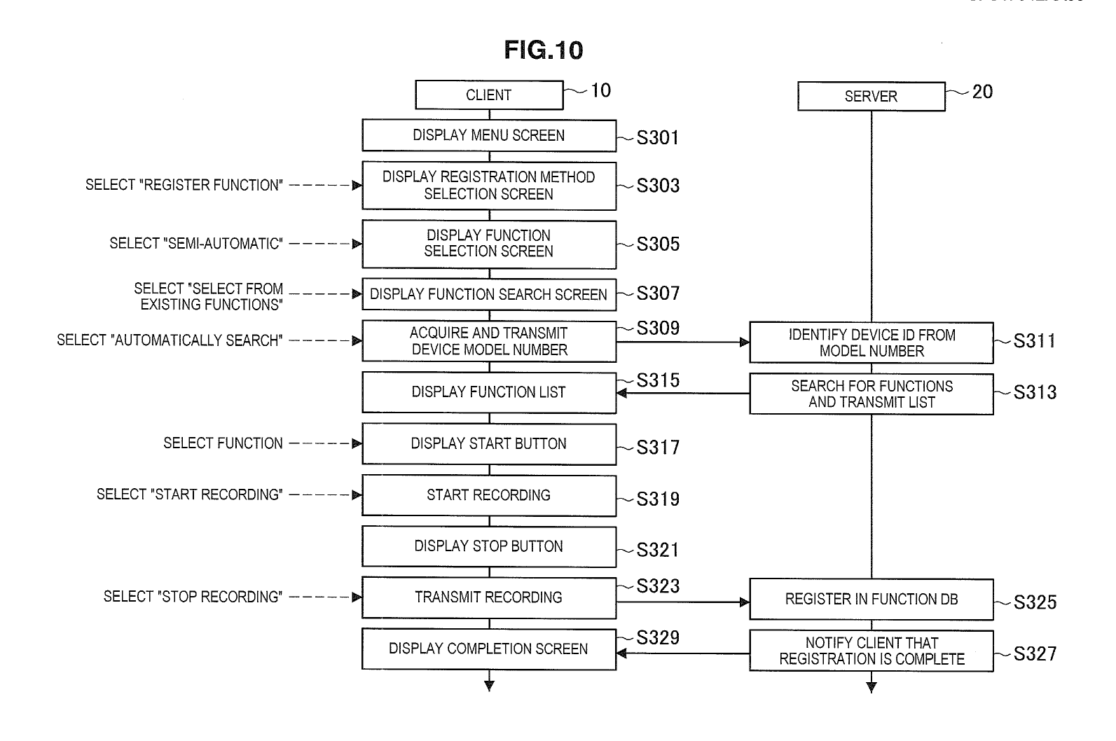

FIG. 10 is a diagram illustrating an example of a flow of the process illustrated in FIG. 9. First, the menu screen 360 is displayed on the client 10 (step S301). At this point, the registration method selection screen 370 is displayed if the user selects the device registration button 361 (step S303). At this point, the function selection screen 380 is displayed if the user selects the semi-automatic button 372 (step S305). Additionally, the function search screen 400 is displayed if the user selects the existing function selection button 381 (step S307).

Herein, the user presses the automatic search button 401 displayed on the function search screen 400, and executes a function search. At this point, at the client 10, the device information acquisition unit 13 internally acquires the device model number of the client 10, and transmits this information to the server 20 (step S309). At the server 20, the device information manager 22 uses the received model number to reference device information stored in the DB 26, and identifies a device ID (step S311).

In addition, the function information manager 23 uses the identified device ID to reference function information stored in the DB 26, and search for functions that may be executed using the device in question as one of the linked devices. More specifically, the function information manager 23 searches for function information 231 in which the identified device ID is included as a Linked Device ID. At this point, the function information manager 23 may also search for function information 231 in which the Linked Device IDs include the identified device ID, and in addition, the other Linked Device IDs are the user's registered devices. In other words, the function information manager 23 may also search for functions that are realizable with devices that the user owns. Function information found by search is transmitted to the client 10 as a function list (step S313).

Upon receiving information about a function list, the client 10 displays a search results screen 410 that includes a function list 411 (step S315). At this point, if the user selects a function, a recording start screen 420 that includes the start button 421 is displayed (step S317). If the user selects the start button 421, the procedure recording unit 14 starts recording operation logs (step S319), and in addition, a recording screen 430 that includes the stop button 431 is displayed (step S321).

When the user selects the stop button 431, the procedure recording unit 14 ends the recording of operation logs, and transmits the recorded procedure to the server 20 (step S323). At the server 20, the procedure information manager 24 registers information on the received procedure in the function DB 230 (step S325). More specifically, the procedure information manager 24 assigns a Procedure ID to the procedure recorded at the client 10, and in addition, sets this Procedure ID in the function information 231 for the function in question. The function information manager 23 also sets the user ID of the user that transmitted the information as the Posting User ID in the procedure information 233. The function information manager 23 records a Procedure in the procedure information 233 according to the operation logs recorded by the user.

Herein, in the case of registering a procedure for an existing function like in the example in FIG. 9, there is a possibility that the same procedure has been registered already in the function DB 230. Thus, in the case of registering a procedure for an existing function, the procedure information manager 24 may also use the Procedure ID information in the function information 231 for that function to search the procedure information 233 and check whether or not a duplicate procedure exists.

When a registration process like the above ends, a registration completion notification is issued from the server 20 to the client 10 (step S327). At the client 10 that has received the registration completion notification, a completion screen (not illustrated in FIG. 9) is displayed (step S329).

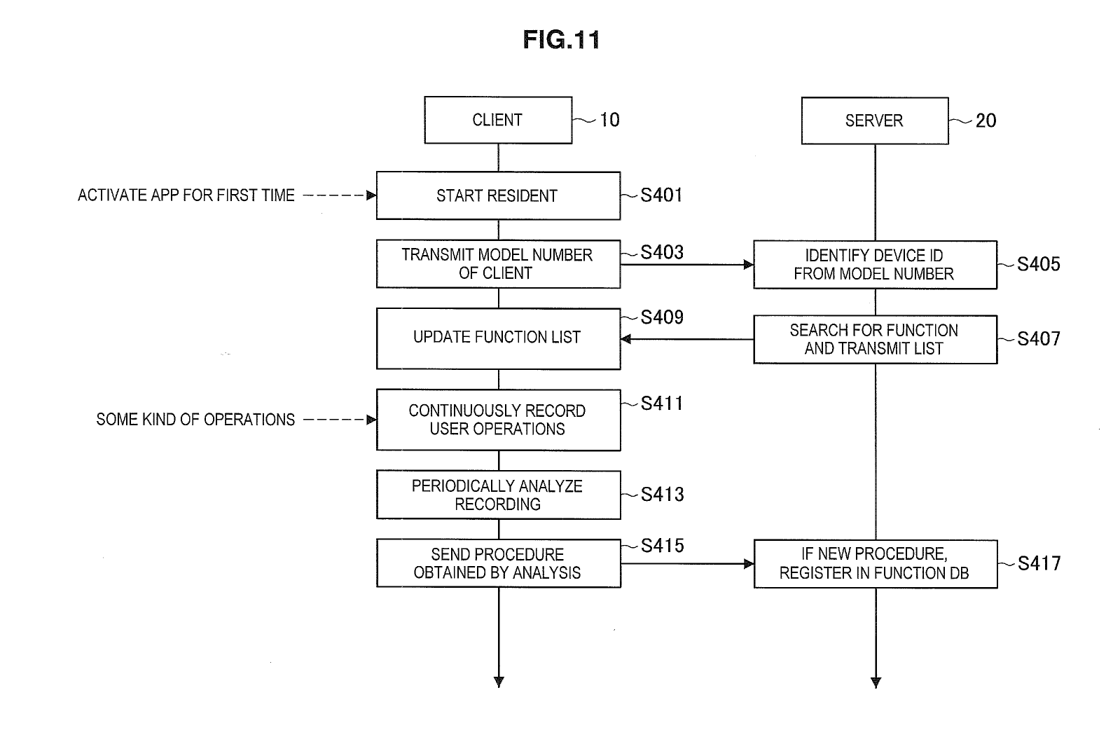

FIG. 11 is a diagram illustrating an example of display screens in a procedure registration process (automatic) according to an embodiment of the present disclosure. When automatically executing a procedure registration process, the client 10 automatically acquires operation logs for operations by the user and transmits the acquired operation logs to the server 20 as described below, and thus the user does not need to perform any particular operations.

First, at the client 10, an application starts a resident activation after the application is activated for the first time (cases other than the first time, such as when changing settings, are also possible) (step S401). Note that in order to enable such resident activation of the application, it is desirable for the client 10 to be capable of multithreaded execution of applications.

While the application is resident, the device information acquisition unit 13 periodically internally acquires the model number of the client 10 (the model number may also be stored after being acquired once), and transmits the acquired model number to the server 20. At the server 20, the device information manager 22 uses the received model number to reference device information stored in the DB 26, and identifies a device ID (step S405).

In addition, the function information manager 23 uses the identified device ID to reference function information stored in the DB 26, and search for functions that may be executed using the device in question as one of the linked devices. Function information found by search is transmitted to the client 10 as a function list (step S407). Note that since the processing in this step is similar to step S313 described in FIG. 10, detailed description thereof will be omitted.

At the client 10 receiving information about a function list, an internally stored function list is updated (step S409). A function list is information about functions that are realizable using the client 10 as one of the linked devices, and is used to analyze operation logs in step S413 discussed later.

Meanwhile, at the client 10, the procedure recording unit 14 continues to record operations executed by the user (step S411). The procedure recording unit 14 periodically analyzes recorded user operation logs (step S413).

Herein, the procedure recording unit 14 detects, from an operation log, an operation corresponding to an executed result of a function included in the function list acquired in step S409. For example, in the case of a function that transfer an image from a mobile device to a TV, the last operation on the mobile device side is the execution of communication for transferring an image, and may be considered as an operation corresponding to an executed result. From a series of previous operation logs corresponding to the executed result, the procedure recording unit 14 specifies a start point of the operations for realizing the function, and extracts operations from the start point to the last operation as operations that indicate an operating procedure for a function.

The procedure recording unit 14 transmits information on operation logs corresponding to the procedure obtained as a result of analysis to the server 20 (step S415). At the server 20, the procedure information manager 24 registers information on this procedure in the function DB 230 in the case where the received procedure information contains a new procedure (step S417). Since the registration processing at this point is similar to step S325 described in FIG. 10, detailed description thereof will be omitted.

(4. Procedure Execution Process)

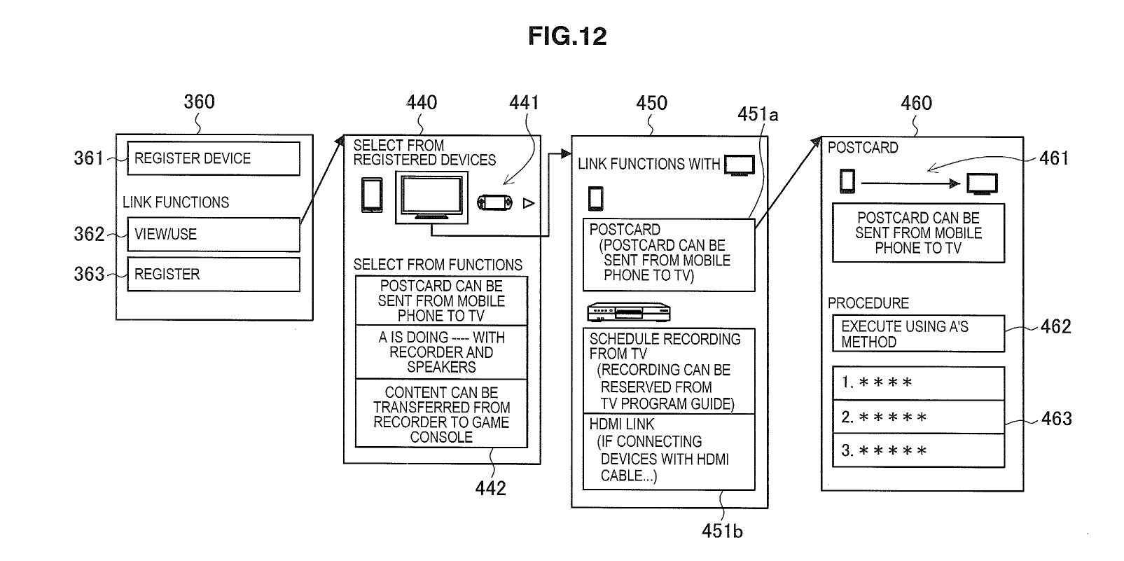

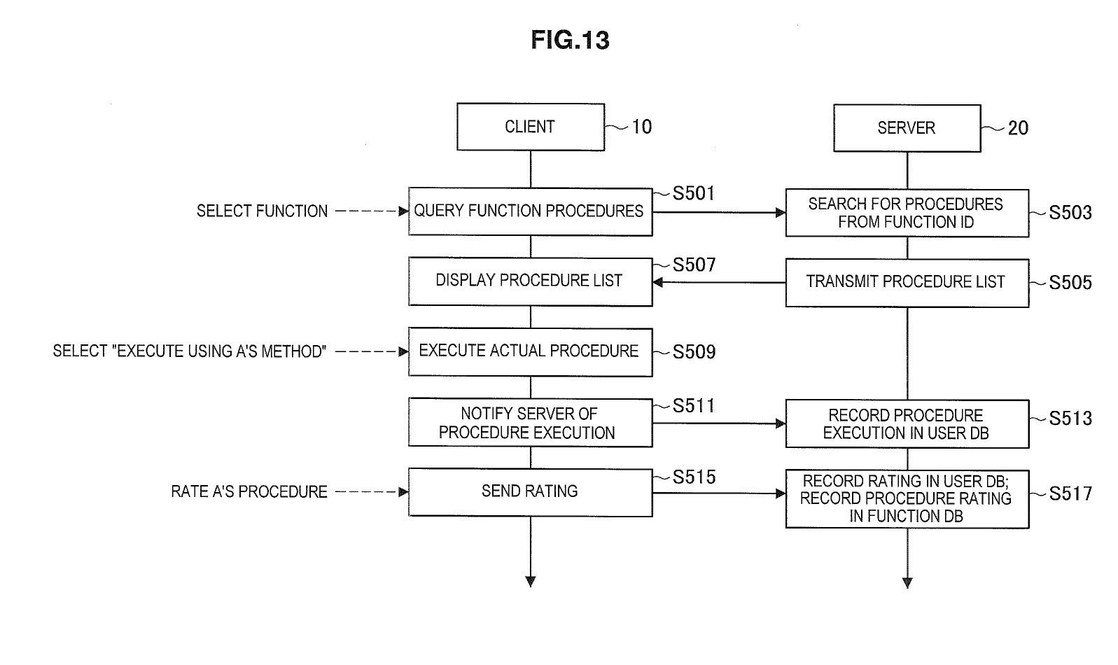

Next, a procedure execution process according to an embodiment of the present disclosure will be described with reference to FIGS. 12 and 13.

According to the above procedure registration process, information on a procedure for realizing a function by device linkage is registered in a system. The procedure execution process uses this procedure information to execute the actual configuration of the device linkage. According to a process like that given by example below, a user is able to refer to procedure information registered by a device manufacturer or another user, and appropriately configure device linkage. Alternatively, a user is able to acquire procedure information provided as program code, and cause a device linkage to be automatically configured.

FIG. 12 is a diagram illustrating an example of display screens in a procedure execution process according to an embodiment of the present disclosure. In the example illustrated in FIG. 12, a menu screen 360 is displayed similarly to the earlier example in FIG. 7. Herein, a procedure execution process is executed if the user selects the view/use function button 362.

In the procedure execution process, first a device/function selection screen 440 is displayed. Displayed on the device/function selection screen 440 are a device selection section 441 and a function selection section 442. Like in the example illustrated in FIG. 12, the device selection section 441 may be an input display in which target devices are selected from among device image icons, for example. The devices displayed as options in the device selection section 441 may be the user's owned devices 100, for example. If the user selects any of the devices in the device selection section 441, a function selection screen 450 is displayed for that device.

Meanwhile, the function selection section 442 may be displayed in a format like the function list in the other examples above. The functions displayed as a function list may be functions that the user uses frequently, or functions recommended on the basis of information such as frequently-used devices, for example. If the user selects any of the functions in the function selection section 442, a procedure list screen 460 is displayed for that function.

On the function selection screen 450, for a device selected in the device selection section 441 of the device/function selection screen 440, there is displayed a function list 451 of functions realized using that device as a linked device. In the example illustrated in FIG. 12, a TV is selected on the device selection section 441. Consequently, on the function selection screen 450, functions realized by linkage between the TV and another device are displayed as a function list 451.

Herein, there are displayed a link function list 451a between the TV and a mobile phone, and a link function list 451b between the TV and a recorder. The devices that link to the selected device may be selected from the user's owned devices 100, for example. In the case where the user selects any of the functions from the function list 451, a procedure list screen 460 is displayed for that function.

Displayed on the procedure list screen 460 are a function description display 461, an automatic execution button 462, and a procedure list display 463, for example. The function description display 461 is a display for indicating to the user the function that is the subject of the procedure list display. In the example illustrated in FIG. 12, the function in question is a postcard function that sends a postcard from a mobile phone to a TV.

The automatic execution button 462 is a button causing a procedure for realizing a function in question by device linkage to be automatically executed by a procedure registered by another user. As discussed earlier, procedure information stored in the server 20 may be acquired as operation logs indicating a procedure executed by another user. For example, if the procedure information manager 24 of the server 20 converts operation logs into program code for storage in the DB 26 as procedure information, it is possible to use procedure information to cause a client 10 to automatically execute a procedure.

Note that in the case of causing a procedure to be automatically executed, in some situations direct operations by the user may be appropriate, such as when selecting a photo, video, or the like to transfer, or when connecting a cable, for example. In this case, automatic execution of a procedure may be temporarily stopped, and a photo, video, or other such selection screen, a display prompting a user operation, or the like may be displayed on a client 10.

The procedure list display 463 displays a procedure for realizing the function in question by device linkage. A procedure displayed at this point may be expressed with text, images, or the like, for example, and the user executes the procedure manually while viewing this display.

The above automatic execution button 462 and procedure list display 463 are displayed for a procedure executable by the client 10 and another of the user's registered devices. In the case of multiple such procedures, multiple automatic execution buttons 462 and procedure list displays 463 may be displayed. In this case, the user selects and executes a procedure from among the multiple displayed procedures. Procedures may be displayed sorted and displayed such that a particular procedure is displayed with a higher rank, such as a procedure with a high procedure rating from users, a procedure by which other users frequently execute a similar function, or a procedure registered by a user who registered another procedure that was previously executed and given a high rating, for example.

FIG. 13 is a diagram illustrating an example of a flow of the process illustrated in FIG. 12. Note that since the processing from when an application is activated on the client 10 to when a function selection screen is displayed (the device/function selection screen 440 or the function selection screen 450) may be easily understood from the other examples above, such processing is omitted from illustration in FIG. 13.

If a user selects some function on a function selection screen, the client 10 queries the server 20 for a procedure (step S501). This query may contain a function ID for the selected function. At the server 20, the function information manager 23 uses the function ID to search for a procedure for realizing the function (step S503). More specifically, the function information manager 23 extracts function information 231 corresponding to the function ID, and additionally extracts procedure information 233 corresponding to one or more Procedure IDs included therein.

The server 20 transmits information on a procedure list found by search to the client 10 (step S505). At the client 10, the received procedure list is displayed (step S507). Herein, the procedure list screen 460 illustrated in FIG. 12 is displayed, for example, and if the user selects the automatic execution button 462, the procedure execution unit 15 executes the selected procedure (step S509). When execution of the procedure ends, a notification indicating that the procedure was executed is issued from the client 10 to the server 20.

At the server 20, the user information manager 21 records information corresponding to the procedure execution in a user DB (step S513). Although not illustrated in the user DB 210 of FIGS. 2 and 3, the user DB may also include a value indicating a count of how many times a procedure registered by a particular user has been executed by other users. The user information manager 21 increments this value in the case where the procedure is executed.

Furthermore, although not illustrated in FIG. 12, after the execution of the procedure, a screen to rate the executed procedure may also be displayed on the client 10. On this screen, if the user input a rating for the procedure, the client 10 transmits this rating to the server 20 (step S515). At the server 20, the user information manager 21 records information on the rating in the user DB similarly to the above execution count, while also recording information on the rating in a function DB. Although not illustrated in the user DB 210 of FIGS. 2 and 3, the user DB may also include an item indicating other users' ratings when a procedure registered by a particular user was executed by those users. Also, although not illustrated in the function DB 230 of FIG. 3, the procedure information 233 of the function DB may also include an item indicating a rating for a procedure. The user information manager 21 and the procedure information manager 24 update these items in the case where a rating for a procedure is transmitted.

(5. SNS Link Process)

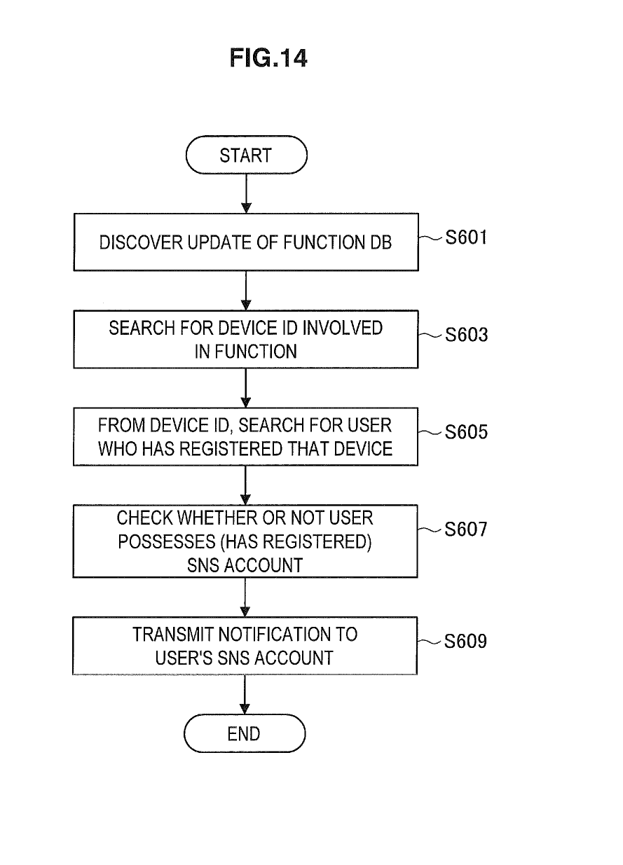

As above, in a system according to an embodiment of the present disclosure, a notification regarding a function may be issued to a user via an SNS that the user utilizes. Hereinafter, an example of a notification utilizing an SNS will be described with reference to FIG. 14.

Note that although in the following example a notification is sent to a user via an SNS in the case of a function update notification, cases in which a notification is issued is not limited thereto. For example, a notification may also be sent in other cases, such as the case where a user registers a new device, the case where a user purchases a new device (the case where user registration is conducted at the time of purchase and a device purchase by a user may be ascertained), the case where the contents of various DBs such as the function DB 230 are updated, the case where a condition for recommendation for a particular function has been satisfied (such as when a smartphone is storing 100 photos, when 15 programs have been recorded by a recorder, or when the playback of a recorded program is stopped partway through, for example), the case where user-owned devices that have a link function are connected to each other, the case where device firmware or application software is updated, or the case where a user's friend on an SNS uses some function.

Thus, a user is able to receive a notification of information related to a link function via an SNS at appropriate timings. Obviously, similar notifications may also be transmitted from the server 20 to a client 10 by another method other than an SNS. For example, an application on a client 10 according to an embodiment of the present disclosure may also be configured to receive push notifications from the server 20.

FIG. 14 is a diagram illustrating an example of a process flow in an SNS link process according to an embodiment of the present disclosure. In the example illustrated in FIG. 14, the server 20 utilizes a user's SNS account information registered as external service information 213 in the user DB 210 to transmit a function update notification to the user's SNS account.

First, the function information manager 23 of the server 20 discovers an update of the function DB 230 (step S601). At this point, the function information manager 23 searches for a device ID used in order to realize the updated function (step S603). More specifically, the function information manager 23 searches for a Linked Device ID in the updated function information 231.

In addition, from a device ID found by search, the user information manager 21 searches for a user who has registered that device (step S605). More specifically, the user information manager 21 searches for a user using a Device ID in the registered device information 211 as a parameter. Additionally, the user information manager 21 checks whether or not a user found by search possesses an SNS account (step S607). More specifically, the user information manager 21 checks whether or not SNS information is registered as external service information 213 for that user.

In the case where the user possesses an SNS account, the user information manager 21 transmits a notification to the user's SNS account (step S609). The notification may take various forms depending on the type of SNS. For example, the notification may be a message transmitted in bulk to all relevant users, or a message respectively transmitted to individual users.

(6. Controlling Linked Devices)

The foregoing describes a process for supporting the configuration of devices that link together, in which a client 10 acquires and utilizes information related to a function provided by device linkage. Herein, the device linkage in question may not necessarily include the client 10 as a linked device. In other words, the client 10 may by proxy configure settings for the linkage of other devices, not including the client 10, by controlling those devices via a network, for example. The control of devices herein may be executed on the basis of operations by a user referring to procedure information, or automatically executed using program code acquired as procedure information, for example.

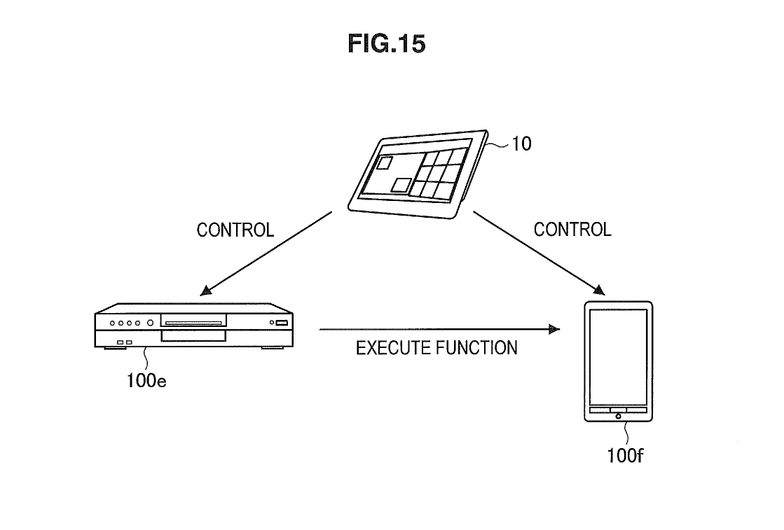

For example, as illustrated in FIG. 15, a client 10 (a tablet) may control a recorder 100e and a smartphone 100f, and cause these devices to execute a link function such as video transfer from the recorder 100e to the smartphone 100f, for example. In this case, the user who had been using the client 10 is able to execute a link function without switching to the smartphone 100f, for example.

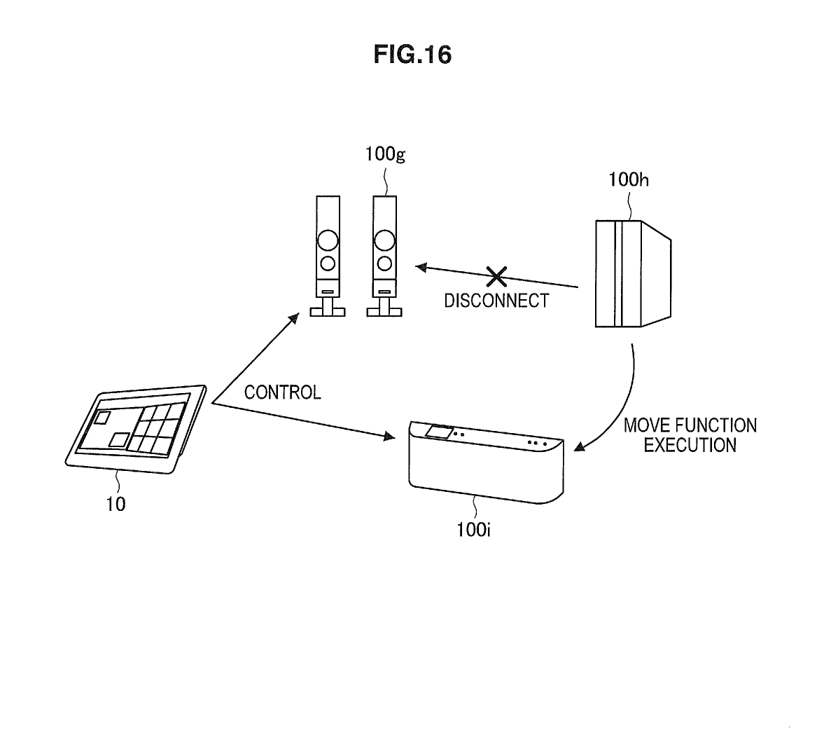

As another example, as illustrated in FIG. 16, a client 10 (a tablet) may control speakers 100g, network-attached storage (NAS) 100h, and another speaker 100i, and change the link function among these devices. For example, in the case of changing the speaker that plays back music content in the NAS 100h from the speakers 100g to the speaker 100i, the client 10 disconnects the speakers 100g from the NAS 100h, and moves execution of the playback function to the speaker 100i. If a user were to execute the above switching operation by respectively operating each device, information such as the playback progress of music content may be lost, for example. However, by having the client 10 control the switch, it is possible to continue the execution of the playback functions while retaining such information.

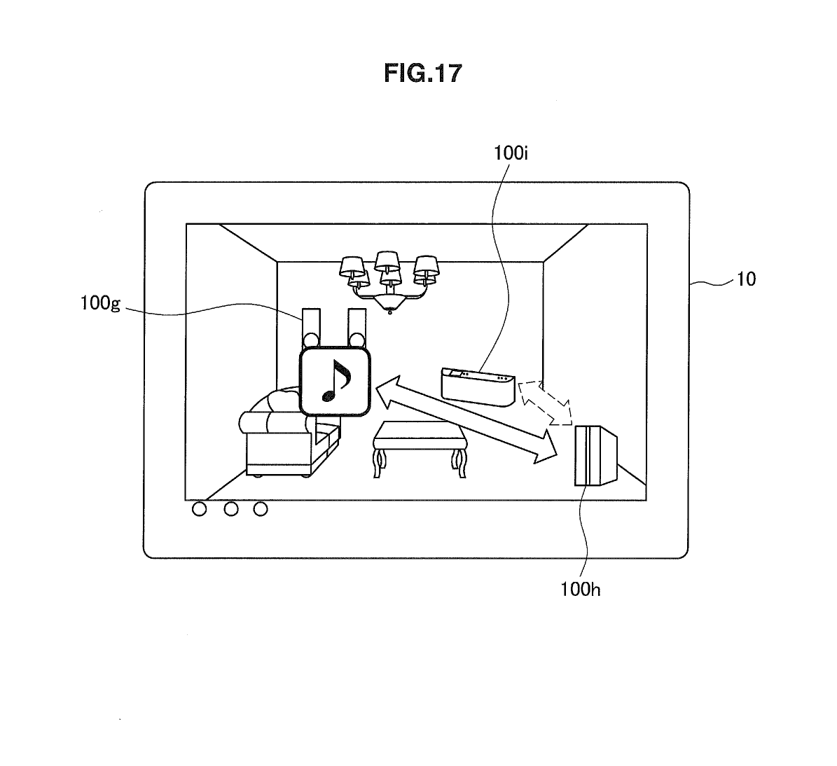

FIG. 17 is a diagram illustrating an example of the user interface from the example in FIG. 16. For example, the user interface (UI) displayed on the client 10 displays the devices 100g to 100i to be controlled as image icons on a living room UI (which may or may not be an actual living room). With such a display, a user is able to recognize link functions from an overall perspective, rather than 1-to-1 relationships between devices.

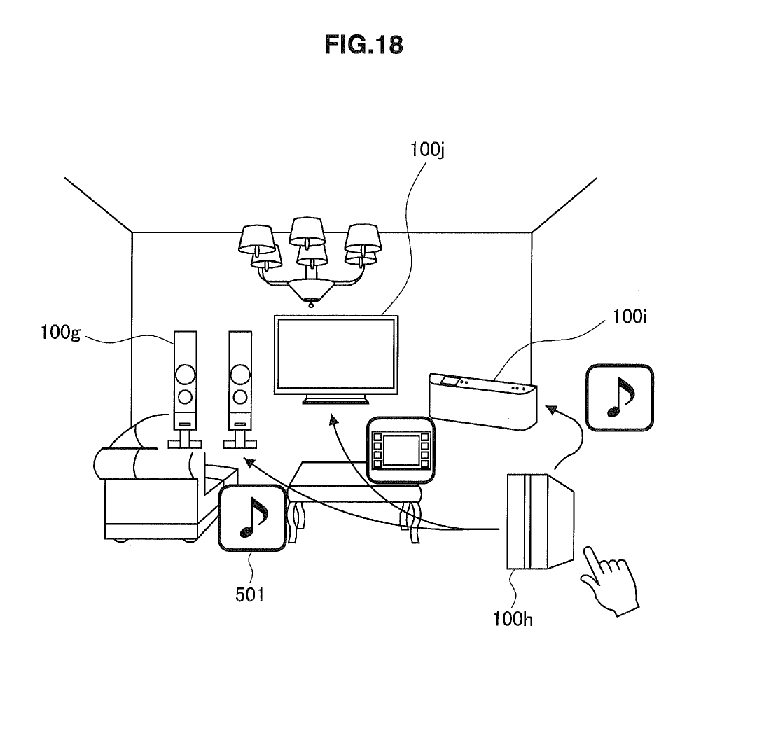

FIG. 18 is a diagram illustrating an example that displays an overview of link functions on the user interface in FIG. 17. In the example illustrated in FIG. 18, a TV 100j is displayed in addition to the devices 100h to 100i. Functions realized by linking respective devices are displayed as lines between devices 100, and as a link function icon 501 corresponding to each line. Herein, a music content playback icon 501a is displayed as a link function between the NAS 100h and the speakers 100g or the speaker 100i, and a video content playback icon 501b is displayed as a link function between the NAS 100h and the TV 100j.

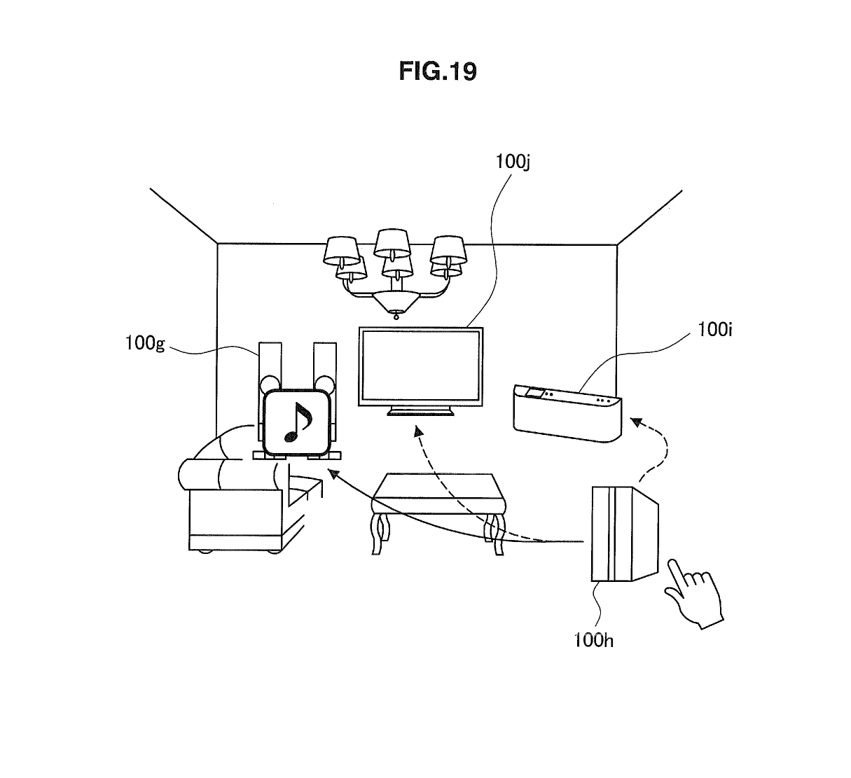

FIG. 19 is a diagram illustrating an example of executing a link function switch on the user interface in FIG. 17. In the example illustrated in FIG. 19, a function being executed (music content playback using the NAS 100h and the speakers 100g) is displayed as a solid line between devices 100 and an icon. On the other hand, realizable functions that are not being executed (music content playback using the NAS 100h and the speaker 100i, and video content playback using the NAS 100h and the TV 100j) are displayed as broken lines between devices 100. For example, in the case of switching the speaker for music content playback from the speakers 100g to the speaker 100i as in the example in FIG. 16, the link function may be switched due to a user tapping the line between the NAS 100h and the speaker 100i.

With a user interface like that of the above examples, other navigation information besides the above may also be displayed when a particular device 100 is selected, such as detailed information on link functions realizable with that device, and a procedure for realizing a link function, for example.

(7. Rating and Recommending Functions)

In an embodiment of the present disclosure, a user is able to rate a link function, and rate a function by posting comments about a link function. In addition to such voluntary ratings from a user, it may be detected from a device operation history that a user has used a function, and the number of times may also be counted, similarly to the case of automatic acquisition of procedure information, for example. In this case, it is also possible to rate a function with a high count as a popular function.

For example, recommending highly-rated functions to users makes it possible to give users guidance on which link functions to use. For example, in the case where a user owns many devices, it is also conceivable that there are too many link functions for the user to try all of them. In such cases, if functions are recommended by the system, it becomes easy for a user to decide which link functions to use, and also gives a user an opportunity to try out link functions.

Furthermore, it is also possible for a user to give additional feedback on a recommended function. For example, given the recommended functions displayed as notification information 313 on the menu screen 310 illustrated in FIG. 5, a user is able to return feedback such as “I'll try it right now”, “Tell me later”, or “Don't tell me again”. In the case of returning the feedback “I'll try it right now”, the configuration procedure for the link function may be displayed directly. In the case of “Tell me later”, notifications indicating that function as a recommended function are suppressed for a given period. In the case of “Don't tell me again”, no further notifications indicating that function as a recommended function are issued.

The following summarizes examples of function recommendation in an embodiment of the present disclosure.

For example, the server 20 may recommend link functions with higher execution counts by users. Also, the server 20 may acquire user ratings, and recommend link functions with higher ratings. Execution counts are recorded as function information 231 in the function DB 230, for example, with the function information manager 23 incrementing an execution count every time the execution of a link function by a user is detected. Since the execution of a link function by a user is automatically detectable by a client 10, for example, such detection does not involve a separate operation by a user. Meanwhile, user ratings are also recorded as function information 231 in a function DB, for example, and updated by the function information manager 23. For function ratings, ratings input into a client 10 at times such as after a user executes a function are acquired.

Also, the server 20 may recommend link functions being used by other users who frequently use similar devices or similar functions. These recommendations are based on the inference that users who use similar devices and functions will tend to use functions in a similar way.

Furthermore, in the present disclosure, devices for realizing a function may also be recommended. For example, the server 20 may recommend a device that a user does not yet own from among devices owned by other users who frequently use similar devices or similar functions. The server 20 may also recommend a device which a user does not yet own, but which is related to a function that the user frequently uses. The server 20 may also recommend a device that many users are newly purchasing, or a device being used in many link functions.

For example, in the case of recommending a device being used in many link functions, the function information manager 23 at the server 20 may count the device IDs recorded as Linked Device IDs in the function information 231 stored in the function DB 230, and recommend a device that is recorded more as a Linked Device ID. Furthermore, if a usage count for each function is recorded as function information 231, the usage count may also be reflected in the count at this point.

(8. Hardware Configuration)

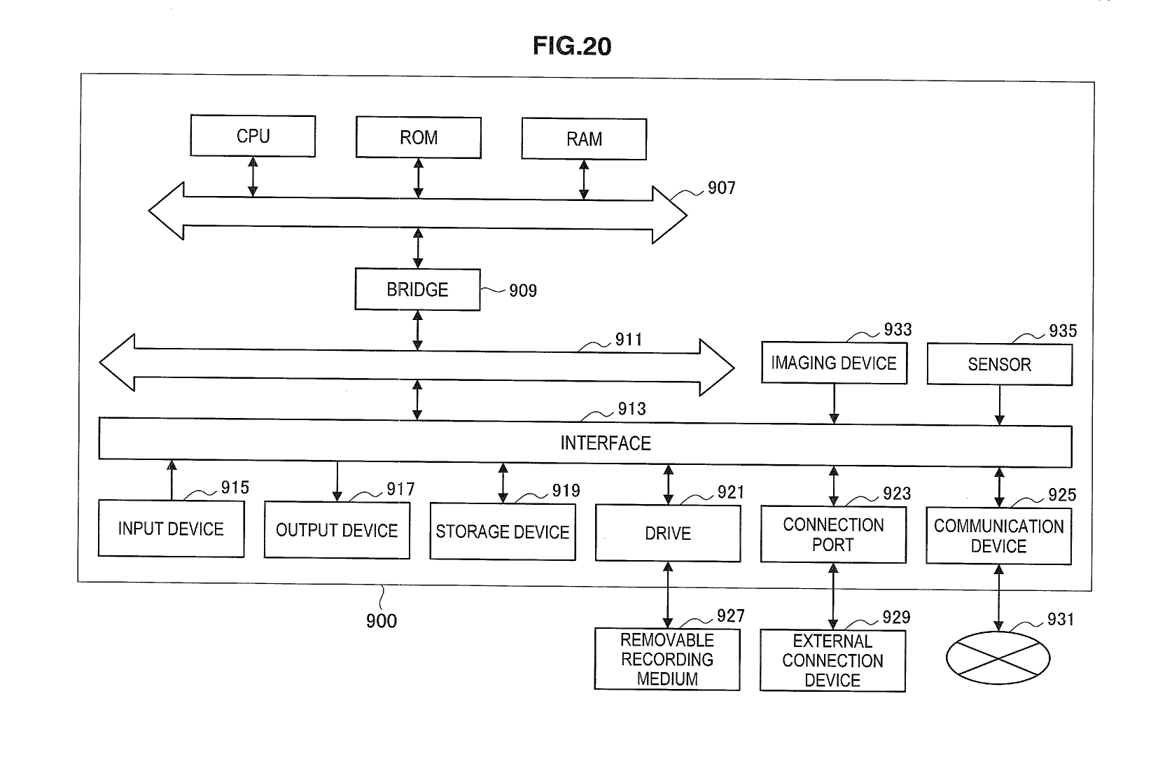

A hardware configuration of the information processing apparatus according to the embodiment of the present disclosure will be described with reference to FIG. 20. FIG. 20 is a block diagram for explaining a hardware configuration of the information processing device. The illustrated information processing device 900 may be implemented as a server device including the client 10 and the server 20 in the embodiments described above, for example.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. Further, the information processing apparatus 900 may include an imaging device 933 and a sensor 935 as necessary. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 may be a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as LCD (Liquid Crystal Display), PDP (Plasma Display Panel), and organic EL (Electro-Luminescence) displays, an audio output device such as speaker and headphone, and a peripheral device such as printer. The output device 917 may output the results obtained from the process of the information processing apparatus 900 in a form of a video such as text or image, and an audio such as voice or sound.

The storage device 919 is a device for data storage which is configured as an example of a storage unit of the information processing apparatus 900. The storage device 919 includes, for example, a magnetic storage device such as HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The imaging device 933 is a device that generates an image by imaging a real space using an image sensor such as a charge-coupled device (CCD) or complementary metal-oxide-semiconductor (CMOS) sensor, as well as various members such as one or more lenses for controlling the formation of a subject image on the image sensor, for example. The imaging device 933 may be a device that takes still images, and may also be a device that takes moving images.

The sensor 935 is any of various sensors such as an acceleration sensor, a gyro sensor, a geomagnetic sensor, an optical sensor, or a sound sensor, for example. The sensor 935 acquires information regarding the state of the information processing apparatus 900, such as the orientation of the case of the information processing apparatus 900, as well as information regarding the environment surrounding the information processing apparatus 900, such as the brightness or noise surrounding the information processing apparatus 900, for example. The sensor 935 may also include a Global Positioning System (GPS) sensor that receives GPS signals and measures the latitude, longitude, and altitude of the apparatus.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

(9. Supplemental Remarks)

Embodiments of the present disclosure encompass an information processing apparatus (a client or a server) and system as described in the foregoing, an information processing method executed by an information processing apparatus or system, a program for causing an information processing apparatus to function, and a recording medium storing such a program, for example.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a user information manager that registers, in a database, registered device information in which devices specified by a user from among devices capable of realizing functions by linking together are associated with the user;

a recommended function determiner that acquires, from the database, function information in which the functions and the devices are associated, and determines recommended functions for the user on the basis of the function information and the registered device information; and

a procedure information manager that acquires, from the database, procedure information indicating operating procedures for realizing a function that the user selects from among the recommended functions, and provides the procedure information to the user.

(2) The information processing apparatus according to (1), wherein

the procedure information manager acquires information indicating the operating procedures executed by another user who has used the function, and registers the acquired information in the database as the procedure information.

(3) The information processing apparatus according to (2), wherein

the procedure information manager provides information explaining the operating procedures to the user as the procedure information.

(4) The information processing apparatus according to (2) or (3), wherein

the procedure information manager provides program code for causing the devices to execute the operating procedures to the user as the procedure information.

(5) The information processing apparatus according to any one of (2) to (4), wherein

the procedure information manager registers a usage count of the operating procedures by the user as the procedure information, and provides the procedure information corresponding to the operating procedures with the higher usage counts to the user.

(6) The information processing apparatus according to any one of (1) to (5), wherein

the devices specified by the user include a device that the user does not own.

(7) The information processing apparatus according to any one of (1) to (6), wherein

the recommended function determiner determines the recommended functions when the database is updated.

(8) The information processing apparatus according to (7), wherein

the recommended function determiner determines the recommended functions when the registered device information is updated.

(9) The information processing apparatus according to (7) or (8), wherein

the recommended function determiner determines the recommended functions when the function information is updated.

(10) The information processing apparatus according to (9), further including:

a function information manager that registers, as the function information, a rating value for the function by a user who has used the function,

wherein, in a case where the rating value corresponding to the function exceeds a given threshold value, the recommended function determiner takes the function to be the recommended functions.

(11) The information processing apparatus according to (9) or (10), further including:

a function information manager that registers, as the function information, a number of times the user has used the function,

wherein, in a case where the number of times corresponding to the function exceeds a given threshold value, the recommended function determiner takes the function to be the recommended functions.

(12) The information processing apparatus according to any one of (1) to (11),

wherein the user information manager acquires information indicating a state of a device that the user owns from among the devices specified by the user, and

wherein, in a case where the state satisfies a condition for recommending the function included in the function information, the recommended function determiner takes the function to be the recommended functions.

(13) The information processing apparatus according to any one of (1) to (12),

wherein the user information manager acquires account information for a social network service that the user utilizes, and

wherein, in a case where a friend of the user on the social network service uses the function, the recommended function determiner takes the function to be the recommended functions.

(14) An information processing apparatus including:

a device information acquirer that acquires information on devices specified by a user from among devices capable of realizing functions by linking together, and transmits the information to a server in order to register the acquired information as registered device information associated with the user; and

a receiver that receives procedure information indicating operating procedures for realizing a function selected by the user from among recommended functions for the user that are determined on the basis of device information in which the functions and the devices are associated, and the registered device information.

(15) The information processing apparatus according to (14), further including:

a procedure recorder that records information indicating operating procedures executed when the user uses the function, and transmits the recorded information to the server.

(16) The information processing apparatus according to (14) or (15), wherein

the receiver receives, as the procedure information, information explaining the operating procedures executed by another user who has used the function.

(17) The information processing apparatus according to any one of (14) to (16), further including:

a procedure executor that causes the devices to automatically execute the operating procedures according to program code;

wherein the receiver receives, as the procedure information, the program code for causing the devices to execute the operating procedures executed by another user who has used the function.

(18) The information processing apparatus according to any one of (14) to (17),

wherein the device information acquirer acquires information indicating a state of a device that the user owns from among devices specified by the user, and transmits the acquired information to the server, and

wherein the receiver receives the procedure information for a function selected by the user from among the recommended functions that are functions for which the state satisfied a given condition for recommendation corresponding to the function.

(19) The information processing apparatus according to any one of (14) to (18), wherein

the devices specified by the user include a device that the user does not own.

(20) An information processing method including:

registering, in a database, registered device information in which devices specified by a user from among devices capable of realizing functions by linking together are associated with the user;

acquiring, from the database, function information in which the functions and the devices are associated, and determining recommended functions for the user on the basis of the function information and the registered device information; and

acquiring, from the database, procedure information indicating operating procedures for realizing a function that the user selects from among the recommended functions, and providing the procedure information to the user.

The present disclosure contains subject matter related to that disclosed in Japanese Priority Patent Application JP 2012-172042 filed in the Japan Patent Office on Aug. 2, 2012, the entire content of which is hereby incorporated by reference.

What is claimed is:

1. An information processing apparatus comprising:
a user information manager that registers, in a database, registered device information in which devices specified by a user from among devices capable of realizing functions by linking together are associated with the user;
a recommended function determiner that acquires, from the database, function information in which the functions and the devices are associated, and determines recommended functions for the user on the basis of the function information and the registered device information; and
a procedure information manager that acquires, from the database, procedure information indicating operating procedures for realizing a function that the user selects from among the recommended functions, and provides the procedure information to the user.

2. The information processing apparatus according to claim 1, wherein
the procedure information manager acquires information indicating the operating procedures executed by another user who has used the function, and registers the acquired information in the database as the procedure information.

3. The information processing apparatus according to claim 2, wherein
the procedure information manager provides information explaining the operating procedures to the user as the procedure information.

4. The information processing apparatus according to claim 2, wherein
the procedure information manager provides program code for causing the devices to execute the operating procedures to the user as the procedure information.

5. The information processing apparatus according to claim 2, wherein
the procedure information manager registers a usage count of the operating procedures by the user as the procedure information, and provides the procedure information corresponding to the operating procedures with the higher usage counts to the user.

6. The information processing apparatus according to claim 1, wherein
the devices specified by the user include a device that the user does not own.

7. The information processing apparatus according to claim 1, wherein
the recommended function determiner determines the recommended functions when the database is updated.

8. The information processing apparatus according to claim 7, wherein
the recommended function determiner determines the recommended functions when the registered device information is updated.

9. The information processing apparatus according to claim 7, wherein
the recommended function determiner determines the recommended functions when the function information is updated.

10. The information processing apparatus according to claim 9, further comprising:
a function information manager that registers, as the function information, a rating value for the function by a user who has used the function,
wherein, in a case where the rating value corresponding to the function exceeds a given threshold value, the recommended function determiner takes the function to be the recommended functions.

11. The information processing apparatus according to claim 9, further comprising:
a function information manager that registers, as the function information, a number of times the user has used the function,
wherein, in a case where the number of times corresponding to the function exceeds a given threshold value, the recommended function determiner takes the function to be the recommended functions.

12. The information processing apparatus according to claim 1,
wherein the user information manager acquires information indicating a state of a device that the user owns from among the devices specified by the user, and
wherein, in a case where the state satisfies a condition for recommending the function included in the function information, the recommended function determiner takes the function to be the recommended functions.

13. The information processing apparatus according to claim 1,
wherein the user information manager acquires account information for a social network service that the user utilizes, and
wherein, in a case where a friend of the user on the social network service uses the function, the recommended function determiner takes the function to be the recommended functions.

14. An information processing apparatus comprising:
a device information acquirer that acquires information on devices specified by a user from among devices capable of realizing functions by linking together, and transmits the information to a server in order to register the acquired information as registered device information associated with the user; and
a receiver that receives procedure information indicating operating procedures for realizing a function selected by the user from among recommended functions for the user that are determined on the basis of device information in which the functions and the devices are associated, and the registered device information.

15. The information processing apparatus according to claim 14, further comprising:
a procedure recorder that records information indicating operating procedures executed when the user uses the function, and transmits the recorded information to the server.

16. The information processing apparatus according to claim 14, wherein
the receiver receives, as the procedure information, information explaining the operating procedures executed by another user who has used the function.

17. The information processing apparatus according to claim 14, further comprising:
a procedure executor that causes the devices to automatically execute the operating procedures according to program code;
wherein the receiver receives, as the procedure information, the program code for causing the devices to execute the operating procedures executed by another user who has used the function.

18. The information processing apparatus according to claim 14,
wherein the device information acquirer acquires information indicating a state of a device that the user owns from among devices specified by the user, and transmits the acquired information to the server, and
wherein the receiver receives the procedure information for a function selected by the user from among the recommended functions that are functions for which the state satisfied a given condition for recommendation corresponding to the function.

19. The information processing apparatus according to claim 14, wherein
the devices specified by the user include a device that the user does not own.

20. An information processing method comprising:
registering, in a database, registered device information in which devices specified by a user from among devices capable of realizing functions by linking together are associated with the user;
acquiring, from the database, function information in which the functions and the devices are associated, and determining recommended functions for the user on the basis of the function information and the registered device information; and
acquiring, from the database, procedure information indicating operating procedures for realizing a function that the user selects from among the recommended functions, and providing the procedure information to the user.
